(19) United States
(12) Patent Application Publication
(10) Pub. No.: US 2006/0184524 A1
(43) Pub. Date: Aug. 17, 2006

(54) Method and system for automated data analysis, performance estimation and data model creation

(76) Inventor: Gunter Pollanz, Hod Hasharon (IL)

Correspondence Address: MILES & STOCKBRIDGE PC, 1751 PINNACLE DRIVE, SUITE 500, MCLEAN, VA, 22102-3833, US

(21) Appl. No.: 11/225,901

(22) Filed: Sep. 14, 2005

Related U.S. Application Data
(60) Provisional application No. 60/609,257, filed on Sep. 14, 2004.

(51) Int. Cl. G06F 17/30

(52) U.S. Cl. 707/6

(57) ABSTRACT

A personal medical information storage and analysis system including a personal medical portal component in communication with a secure patient database and a patient with secure personal medical information stored in the secure patient database, and the secure patient database being a personal medical portal component in communication with the secure patient database within which personal medical information on a patient is to be stored. The system further including an access control component in communication with the secure patient database for the patient to enable access to said personal medical information by healthcare providers; and a data profiling component in communication with the secure patient database and the data profiling component to be used by the patient to prepare a self-profile from the patient's secure personal medical information. The system still further includes the secure patient database being accessible by healthcare providers for the personal medical information that they individually provided to the at least one secure patient database without further authorization from the patient.

### CROSS-REFERENCE TO RELATED APPLICATION

This application claims priority to and the benefit of U.S. Provisional Patent Application Ser. No. 60/609,257, filed on Sep. 14, 2004.

### BACKGROUND

While all known medical data communication systems are part of or linked to medical service provider(s) (Doctors, HMO/PPO/etc., Hospitals, Pharmacies, etc.) there is no system that is entirely independent from the data source. In the US, and similar in any other democratic nation worldwide, the Patient's right of obtaining, possessing, accessing and using his personal medical information is legally protected. In the US that right is embedded in the First Amendment of the Constitution with the latest reaffirmation of the right being in the Patient's Bill of Rights Act of 1999. Unfortunately, despite the Act, there are still bundles of conflicting rules, at both the state and federal level, that contradict the patient's right to obtain access and use his/her own personal medical data at will.

The executive laws that deal with the use of medical data in accordance with the provisions of the Patient's Bill of Rights Act, are summarized under the Health Insurance Portability and Accountability Act of 1996 (HIPAA), which was signed into law on Aug. 21, 1996. This law includes important new protections for millions of working Americans and their families who have preexisting medical conditions or might suffer discrimination in health coverage based on a factor that relates to an individual's health

Still, the language used contradicts the goal set, because HIPPA does not deal with the patient but with medical service providers (MSPs) and sets the rules that third party MSPs have to fulfill when communicating Patient Information. Therefore and even under recent or present legal changes in the US and world wide, the patient cannot execute his legal right of obtaining, possessing, accessing and using his personal medical information due to the absence to technical tools that allow him/her to obtain such data; the absence of the capability and willingness of MSPs to provide such data in meaningful way to the patient; and the absence of tools and technology that allows the patient to interpret his/her own medical data in accordance with the latest, available medical knowledge management tools and applications. Thus, the Patients Rights Act 1999 remains a bombastic PR-declaration whilst it does not enforce, or even suggests, MSPs to change their policy and to start providing the patient with the relevant personal medical data.

Moreover medical laws, both state and federal, do not enforce the obvious, namely to dictate that all personal medical data of a patient must be available at any time and any place. To the contrary, medical laws are written and designed to protect the doctor, the hospital or other MSPs securing that the patient cannot enter into his own medical account at the doctor or the hospital thus being denied the option for control and comparison.

Patients Rights Privacy Legislation that forbids the transfer of patient data from one doctor to another or from one hospital to another blocks the simplest of requests of “I want my data” by patient and governmental health policy alike. While the need and reasonability of such legislation is understood, it, unfortunately, leaves the patient in an unsolvable conflict where the only one to be harmed is the patient: If the patient wishes to have his/her data now, for example, if he/she needs the data in order to inform a treating doctor, or request a second opinion. He/she must order that such data be sent to him/her and that he/she hereby confirms that the doctor and/or Hospital are removed from its data-protection-obligation. Unfortunately, this right is not enforceable due to lack of technical tools on the side of the receiving patient as well as on the side of the sending MSP.

Another area of discontent can be seen in the use of coded data by, for example, the World Health Organization (WHO) designed Diagnostic- and Therapeutic-Coding ICD-10, which is equivalent, in the US, to the still widely used ICD-9. Although such codes are used nationally and internationally for claim-settlements, the codes are not routinely entered in a patient record.

By denying to enter such codes into an electronic patient record, the authorities who demand such (e.g., Government, doctors, Hospitals, HMOs) deny a patient the automatic risk-evaluation-function that is available with pharmaceutical companies, but not with the HMO and certainly not with the doctor. Such a risk evaluation-function is an application that draws data from medication, lab-results and ICD-10 Diagnostic-Codes, thus allowing the doctor and/or hospital care personnel instantly to cross-evaluate all items. A patient that enters the hospital with high blood pressure would be given automatically a blood-pressure-reducing medication, without the hospital knowing that the patient has, e.g., Angina Pectoris, whereby the intended medication could be fatal.

The availability of (as complete as possible) personal medical data is the precondition for any medical data knowledge-management. While the patient is not requested to set the parameter for an analysis (such is done by professional experts such as HMOs, Pharmacists, etc) there is no reason why the patient should not gain access to such analytical results. The American Medical Association (AMA) estimates that every, year some 100,000 patients die in the US due to undetected, false medication. Naturally, like with prescription medication, the patient is provided with the following instructions: “. . . for further information and guidance please contact your pharmacy or your general practitioner . . . .” But, again, there is no reason why a patient should not be alerted about a potential danger from a new medication—even if such has to be confirmed by his HMO. It is the request of the Health Secretary and of all recent US-Administrations that the patient be permitted to monitor his own Health-Status and to become a competent and reliable partner. Such a system and collaboration to increase patient participation will reduce the soaring Health Costs far more that any attempts to block medication costs.

### BRIEF DESCRIPTION OF THE DRAWINGS

The present invention will be described with reference to the accompanying drawings.

FIG. 1 is a block diagram of a system in which a patient medical portal (PMP) may be implemented to enable direct patient access and control over the patient's personal medical data and information, in accordance with one or more embodiments of the present invention.

FIG. 2 is a screen shot of a welcome page of a web-based implementation of the PMP, in accordance with one or more embodiments of the present invention.

FIG. 3 is a screen shot of a medical history (Anamnesis) page of the web-based implementation of the PMP, in accordance with one or more embodiments of the present invention.

FIG. 4 is a screen shot of a summary medical events page of the web-based implementation of the PMP, in accordance with one or more embodiments of the present invention.

FIG. 5 is a screen shot of a detailed medical events page for event 1 listed in FIG. 4 of the web-based implementation of the PMP, in accordance with one or more embodiments of the present invention.

FIG. 6 is a screen shot of a bottom portion of the detailed medical events page for event 1 shown in FIG. 5 of the web-based implementation of the PMP, in accordance with one or more embodiments of the present invention.

FIG. 7 is a screen shot of a new medical events page of the web-based implementation of the PMP, in accordance with one or more embodiments of the present invention.

FIG. 8 is a screen shot of a next-lower section of the new medical events page 700 of FIG. 7, in accordance with one or more embodiments of the present invention.

FIG. 9 is a screen shot of a still next-lower section of the new medical events page 700 of FIGS. 7 and 8, in accordance with one or more embodiments of the present invention.

FIG. 10 is a screen shot of a bottom-most section of the new medical events page 700 of FIGS. 7-9, in accordance with one or more embodiments of the present invention.

FIG. 11 is a screen shot of a medication data input page of the web-based implementation of the PMP, in accordance with one or more embodiments of the present invention.

FIG. 12 is a screen shot of a new medication page of the web-based implementation of the PMP, in accordance with one or more embodiments of the present invention.

FIG. 13 is a screen shot of a new medical event diagnostic code (ICD- 10) data input page of the web-based implementation of the PMP, in accordance with one or more embodiments of the present invention.

FIG. 14 is a screen shot of a new medical report file upload page of the web-based implementation of the PMP, in accordance with one or more embodiments of the present invention.

FIG. 15 is a screen shot of a new medical report file link page of the web-based implementation of the PMP, in accordance with one or more embodiments of the present invention.

FIG. 16 is a screen shot of a new image file upload page of the web-based implementation of the PMP, in accordance with one or more embodiments of the present invention.

FIG. 17 is a screen shot of a new image link page of the web-based implementation of the PMP, in accordance with one or more embodiments of the present invention.

FIG. 18 is a screen shot of a new image file upload page of the web-based implementation of the PMP, in accordance with one or more embodiments of the present invention.

FIG. 19 is a screen shot of a laboratory results data input page of the web-based implementation of the PMP, in accordance with one or more embodiments of the present invention.

FIG. 20 is a screen shot of a quick box page 2000 of the web-based implementation of the PMP, in accordance with one or more embodiments of the present invention.

FIG. 21 is a screen shot of a laboratory results page of the web-based implementation of the PMP, in accordance with one or more embodiments of the present invention.

FIG. 22 is a screen shot of a laboratory results page 2100 of the web-based implementation of FIG. 21, in accordance with one or more embodiments of the present invention.

FIG. 23 is a screen shot of a medication risk check page 2300 of the web-based implementation of FIG. 23, in accordance with one or more embodiments of the present invention.

FIG. 24 is a screen shot of a registration details page 2400 of the web-based implementation of the PMP, in accordance with one or more embodiments of the present invention.

FIG. 25 is a screen shot of a contact details page 2500 of the web-based implementation of the PMP, in accordance with one or more embodiments of the present invention.

FIG. 26 is a screen shot of a medical data page 2600 of the web-based implementation of the PMP, in accordance with one or more embodiments of the present invention.

FIG. 27 is a screen shot of an emergency instructions page 2700 of the web-based implementation of the PMP, in accordance with one or more embodiments of the present invention.

FIG. 28 is a screen shot of a health insurance page 2800 of the web-based implementation of the PMP, in accordance with one or more embodiments of the present invention.

FIG. 29 is a screen shot of a non-medical documents page 2900 of the web-based implementation of the PMP, in accordance with one or more embodiments of the present invention.

FIG. 30 is a screen shot of a registration details/payment confirmation page 3000 of the web-based implementation of the PMP, in accordance with one or more embodiments of the present invention.

FIG. 31 is a screen shot of a search documents page 3100 of the web-based implementation of the PMP, in accordance with one or more embodiments of the present invention.

FIG. 32 is a screen shot of a download page 3200 of the web-based implementation of the PMP, in accordance with one or more embodiments of the present invention.

FIG. 33 is a screen shot of an online pharmacy page 3300 of the web-based implementation of the PMP, in accordance with one or more embodiments of the present invention.

FIG. 34 is a screen shot of a health manager page 3400 of the web-based implementation of the PMP, in accordance with one or more embodiments of the present invention.

FIG. 35 is a screen shot of a welcome page 3500 of a web-based implementation of the MDP that may be displayed after successfully logging on to the MDP, in accordance with one or more embodiments of the present invention.

FIG. 36 is a screen shot of a summary medical events page 3600 of the web-based implementation of the MDP, in accordance with one or more embodiments of the present invention.

FIG. 37 is a screen shot of a new medicine page 3700 of the web-based implementation of the PMP of FIGS. 11 and 12 and the MDP of FIG. 35, in accordance with one or more embodiments of the present invention.

FIG. 38 is a screen shot of a welcome page 3800 of the Light version of the PMP system previously described, in accordance with one or more embodiments of the present invention.

FIG. 39 is a flow diagram of a method of implementing a patient personal medical portal to be controlled and accessed by the patient, in accordance with one or more embodiments of the present invention.

FIG. 40 is a block diagram of a system infrastructure for a PMP that may be implemented to enable direct patient access and control over the patient's personal medical data and information, in accordance with one or more embodiments of the present invention.

### DETAILED DESCRIPTION

Embodiments of the invention relate to a central patient communication health management system, a so-called health management system, from which medical data is taken by Software Tools from any data archive in any data format and either stored in, or linked to, a personal medical portal (PMP) that is owned by the patient (i.e., user or citizen). By storing personal medical data in a patient owned data repository, the PMP, data integration tools may allow any possible medical or lifestyle data analyses without the need to call up or ask for access to data that generally is hidden at medical institutions, doctor, hospitals, HMOs or research institutes. The legal basis for that data-call by the individual citizen is the US Patient's Bill of Rights Act of 1999 and all corresponding state and federal legalizations on the rights of the citizen to unhindered access to his/her personal medical data. Embodiments of the invention may define a business method that uses solid legal grounds to force medical service providers to hand over personal medical data to the citizen, if he/she asks for it. In general, such data has to be changed into structured data so it can be used for data analysis and data monitoring. In accordance with embodiments of the present invention, the system further connects such individually based personal medical data with large, publicly available medical databanks (pharmacy-, epidemic-, cancer-, etc.) that allow the patient to profile his present data with publicly known data-schemes that were developed on such public databanks.

Embodiments of the present invention may include an Internet-based portal for patient personal medical records referred to as a personal medical portal (PMP), and a medical doctors portal (MDP) for doctors, Hospitals and (medical and pharmaceutical) R&D companies named. Embodiments of both portals may include one or more related side products and connected applications that are intended to facilitate the collection of personal, medical data form any source, whether medical or non-medical. The portals are implemented to be easily upgraded to incorporate technological developments in data and communication technologies and with newly available (medical) Informatics knowledge and technologies that are designed to improve collection of personal medical (patient) data. In addition, the portals may be implemented to provide such data for instant call-up and interfacing with applications provided by professional, medical sources. Embodiments of the portals may be designed to enable patients and their multiple record holders, whether professional medical or laymen data operators, to connect to and interface with third-party (medical) applications. These third-party applications may include, but are not limited to: Disease Management Programs (DMPS); Therapeutic programs; Internet/E-Pharmacies, medical and/or pharmaceutical R&D programs; applications that are provided by medical professional individuals (doctors, Pharmacists, Laboratory Data Experts, etc.) or organizations like Universities, University-Hospitals, Hospitals, Laboratories, Pharmacies, Pharmaceutical Companies, HMOs, and other organizations who provide and/or interpret medical information; Laymen Organizations who collect, store or provide patient medical information, for example, Fitness Studios, Sports clubs, Nutrition advisors, Health-Portals and Health-Managers run by Internet-Service-Providers, etc.; and HMOs, Health Funds, Insurance companies, Social Security, etc.

In some embodiments of the present invention, a patient who has his data stored in a PMP in one country, for example, Germany, might have a medical emergency while in Japan or Kuala Lumpur. Fortunately the PMP allows the patient and his treating doctors to change the language in which the header of the PMP is displayed to any language that is necessary. However, although at present only about nine different languages have been enabled, additional languages are planned to be available as required by the country in which the system may be implemented/available. While the body of the original document cannot be changed into another language due to the risk of currently available Internet-based language-translation programs translating medical terms incorrectly being too great, any coded information, for example, ICD-10 codes, are available in 36 languages; lab-test reports can be viewed in any language, as the chemical terms used are internationally; and X-rays speak for themselves allows, because a Japanese speaking doctor can figure out the basic problems and profile of a patient from the X-ray without having to speak the language of the country from which the X-ray was provided, for example, German or English.

It is these realities that enforces again the need for a patient based system, due to governmental restrictions on the communication of medical data by doctors, an American patient who falls sick in Japan has no way to accessing his medical records/data at the Duke University, or with his private doctor, unless someone is available and can be convinced to provide the medical records/data. Because data-availability might be vital and life-saving the concept of state-laws, or in a wider sense federal laws, of restricting medical data flow to the local doctor and hospital is out of touch with the realities of the modern lifestyle. For example, a patient can register today with an HMO in Los Angeles, but travel the next day to NY, or even abroad and may need to have access to his medical data due to an accident or illness.

Presently, HMOs in the US are the legal owners of the data. Still, they have the obligation to provide copies of medical data to the patient. As long as that is done, the question of the ownership of data is irrelevant. In Germany, if Laboratories start sending the original data set of blood-test-results directly to the patient, while still sending the same data set to the doctor. As a doctor can generally only see the laboratory data that he/she has ordered to be done, the entire availability of ALL laboratory results is of vital importance, like the availability of ALL medication and ALL diagnostic codes.

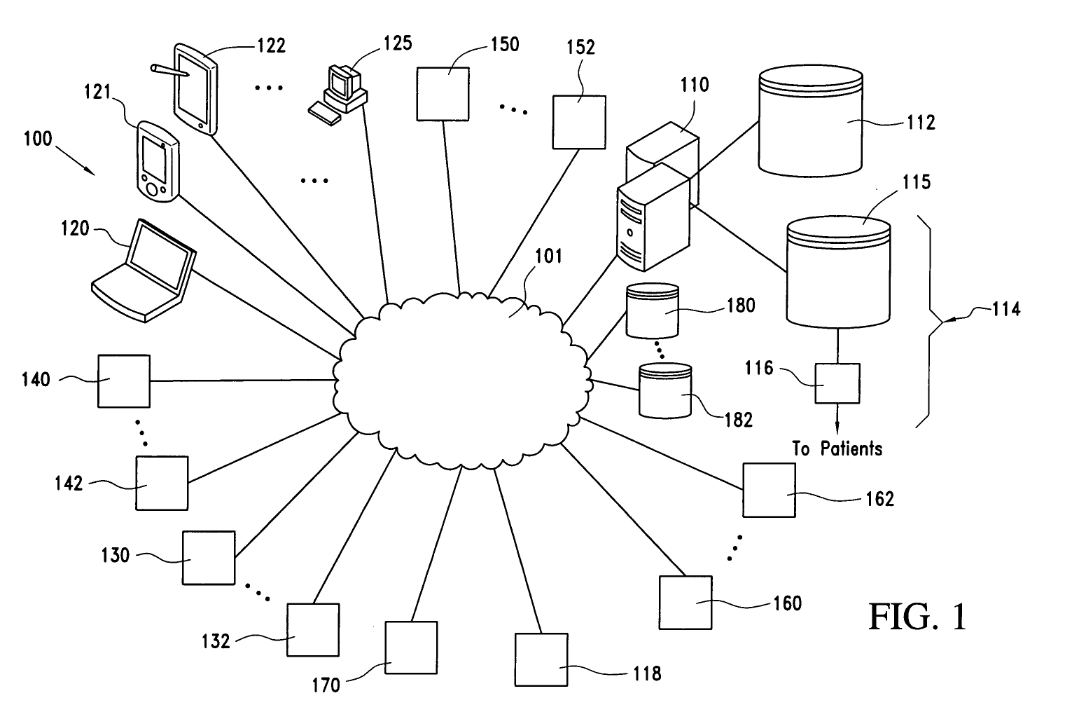

FIG. 1 is a block diagram of a system in which a PMP may be implemented to enable direct patient access and control over the patient's personal medical data and information, in accordance with one or more embodiments of the present invention. In FIG. 1, a PMP system 100 may include a network 101, for example, but not limited to, the Internet, a local area network, wide area network, and the like. Network 101 may be in communication with one or more servers 110, which in turn may be connected to a secure patient database 112 in which secure personal medical portals (e.g., databases) may be created and maintained for individual patients who have subscribed to the service, and to an Internet pharmacy 114, which may include a prescription program and database 115 and a warehouse/shipping facility 116 and may enable electronic ordering, filling and direct delivery of prescriptions to patients who have paid to access the system on servers 110. Servers 110 may be used to implement an embodiment of a PMP program as a web-based system written in, for example, Extensible Markup Language (XML) along with its attendant structural framework, database(s), documents, rules, and object instantiation (creation) and deletion. Although, Internet pharmacy 114 is shown in FIG. 1 connected to servers 110, Internet pharmacy may be connected directly to and accessed through network 101 as an electronic prescription system 118, which may permit other systems to access and take advantage of electronic prescription ordering and mail delivery. Alternatively, Internet pharmacy 114 and/or electronic prescription system 118 may also or only have a traditional pharmacy, commonly referred to as a brick and mortar store front, that can receive electronic prescriptions but only fills the prescriptions for patients who come in and pick them up in the store.

In FIG. 1, multiple users, i.e., patients, may access the PMP program on servers 110 over network 101 using a variety of hardware devices/systems. For example, a patient may access the PMP program directly using a hardwired connection as well as wirelessly using a laptop 120, a personal digital assistant (PDA) 121, a tablet computer 122 (e.g., a Palm® Pilot), and a regular personal computer 125. Although not shown in FIG. 1, other methods of connecting to the system are possible including, but not limited to, a web phone, a cell phone, a smart phone, a satellite phone, etc. Users who connect to the PMP program on servers 110, may control which third parties may have access to read and/or write medical information on the user into that user's PMP in secure patient database 112. These third parties may include one or more doctors 130, 132; one or more pharmacies 140, 142; one or more laboratories 150, 152; one or more hospitals 160, 162; one or more research organizations 170; and one or more pharmaceutical databases 180, 182 (e.g., a US and a German pharmaceutical database).

The ability of the system to be accessed using wireless devices can be a vitally important feature. This is especially true when dealing with the hourly welfare of a Diabetes patient, since it is of utmost importance that the measured Glucose-values of the patient enters the portal as soon as possible, which may be accomplished using a wireless phone or other communication device. In general, present measuring systems allow the patient to store the actual Glucose value, which some patients measure up to 6 and more times a day, on a small, digital device. Unfortunately this data only reaches a monitoring system, if at all, when the patient goes, at the end of the day, to his doctor who, if he has time, connects the patient's digital device to the doctor's data program, provided the doctor has purchased one. Only then would the patient and his doctor know, that the Glucose data 12 hours ago, or 12 days ago, had reached a critical, and sometimes life-threatening level. The online monitoring capability of the system can avoid the above scenario, because the patient can send his data through his wireless phone as soon as the measuring device determines it, and any alarm situation can be sent back to the patient automatically. Although such monitoring systems exist in the market, none operates to send the patient's data wirelessly into his patient portal and obtaining an alarm by e-Mail or SMS instant message instructing him either to connect to his Monitoring-Supervisor or instructing him to contact an doctor immediately.

In accordance with one or more embodiments of the present invention, the PMP program implemented in servers 110, in FIG. 1, may perform data-integration (i.e., the combination of the medical data of a patient with a diagnostic- and/or therapeutic program of an MD or a University Hospital, i.e., Medical Knowledge Management) and data-facilitation (i.e., provide and facilitate personal medical data in such a way, that the data can be used by a medical service without having to change their own data program in order to be able to read and use the patient's data from the patient's portal). Therefore, the embodiments of medical knowledge management applications and programs are designed in cooperation with medical professionals, to provide the raw-data that was and is accumulated over years, and the medical service provider analyses the data according to its specific needs and goals. As a result, while the patient may own only his/her personal data repository (where all of his/her individual data may be stored), there are hundreds, if not thousands, of medical applications on the market; each offering tailored solutions to the patient conditionally that they will gain access to the patient's data.

In general, the PMP program on servers 110, in FIG. 1, provides a secure personal health record database with access controlled by the user (i.e., patient), but accessible by healthcare providers to enter and read information, if authorized by the user. The PMP program may permit the user and authorized healthcare providers to perform general queries concerning risks and condition, specific queries and prepare reports for conditions and symptoms and medication specific queries and reports; review personal medical health information; correct/update the personal health information;

In accordance with one or more embodiments of the present invention, in the personal medical portal system the ultimate owner and exclusive authority over an individual's (patient's) personal medical information is the individual (patient). Thus, it is the exclusive right of a subscribing patient to decide to whom he/she is granting (full or partial) access to his/her medical information. The system may implement this function with an Internet-based Access Authorization Tool (AAT) that allows the patient to initiate and grant access rights to medical partners. In general, no partner will be able to access all or any part of an individual's PMP without the explicit access authorization granted by the patient through his/her AAT. The partners may include MDs, HMOs, Hospitals, Laboratories (medical) governmental and non-governmental R&D, and governmental and non-governmental statistical services. R&D by pharmaceutical companies etc., unless regional, national or international laws order or demand such access (i.e. in cases of epidemics) or courts order such access (i.e. danger of life, mental illness, or similar).

In accordance with an embodiment of the present invention, and in order to visualize the general way in which the system works, the following fictitious examples are provided on how to access the system.

### EXAMPLES

1. www.cepco.net

2. Chose the appropriate language (e.g., English, German, etc.) by clicking on an appropriate language flags.

3. Click on LOGIN

4. Enter the test Patient:
User: Demo
Passw: DA13
ID: Demo
Mr. Peter Mustermann 1958-
01-10 Schellingstr. 119 80798
Muenchen Germany
5. Go to Medical History (Anamneses) and scroll down to Medication.
6. Click on Buy-it and use all the features there.

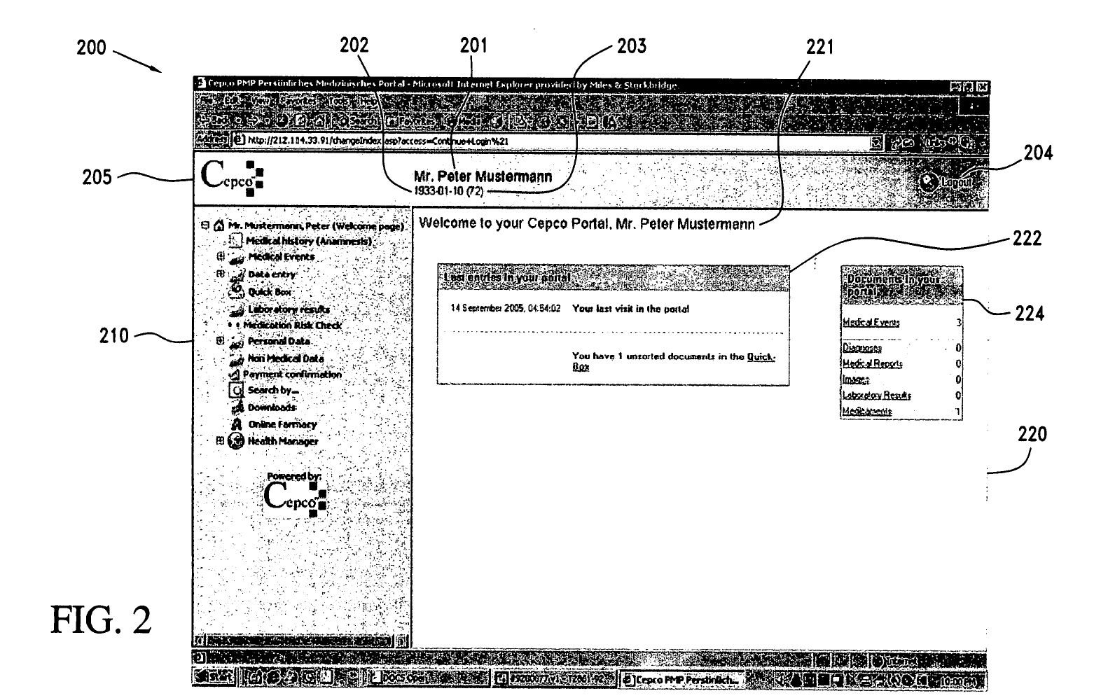

FIG. 2 is a screen shot of a welcome page 200 of a web-based implementation of the PMP that may be displayed after successfully logging on to the PMP, in accordance with one or more embodiments of the present invention. In FIG. 2, welcome page 200 may include patient specific data including a patient name 201, a patient date of birth 202 and a patient age 203, as well as a logout button/icon 204 in a top section 205 of welcome page 200 to log out of the PMP. Welcome page 200 may also include a lower left section 210 in which the options to control and/or access the data in the PMP are located. These options may include, but are not limited to, medical history; medical events (list all and add a new event); data entry (new medication, new diagnosis, new medical report, radiology/images, new laboratory results, quick box). The quick box is a tool that allows the patient or his doctors to enter medical data without routing such data directly to the correct, relevant medical event. Experience in working with doctors has shown, that they are ready to send instantly digital or documents data to the patients' portal, but have no time to choose to which medical event such data belongs. As a patient can have up to several hundreds of medical events, data is floating first into the Quick Box. Once data is in the Quick Box (i.e. a new medication, or a new ICD-10 code), all portal-functionalities like Medication-Incompatibility-Check etc. include the data in the Quick Box as sell. This tool is designed that the patient can receive data and documents at any given time. The patient can now enter his PMP at a later time or date and refer all accumulated new data that are stored in the Quick-Box to the relevant medical event. Even if the patient leaves all data in the Quick-Box, the functionality of the portal refers to it properly; laboratory results; medication risk check; and personal data. Welcome page 200 may also include a lower right section 220, which may contain a greeting message 221 for Mr. Peter Mustermann, a last entry information box 222 that may provide details on the last visit and/or visits that the user made to the PMP and a document list box 224 that details the number of documents associated with each type of data, for example, medical events, diagnoses, medical records, images, laboratory results, and medications.

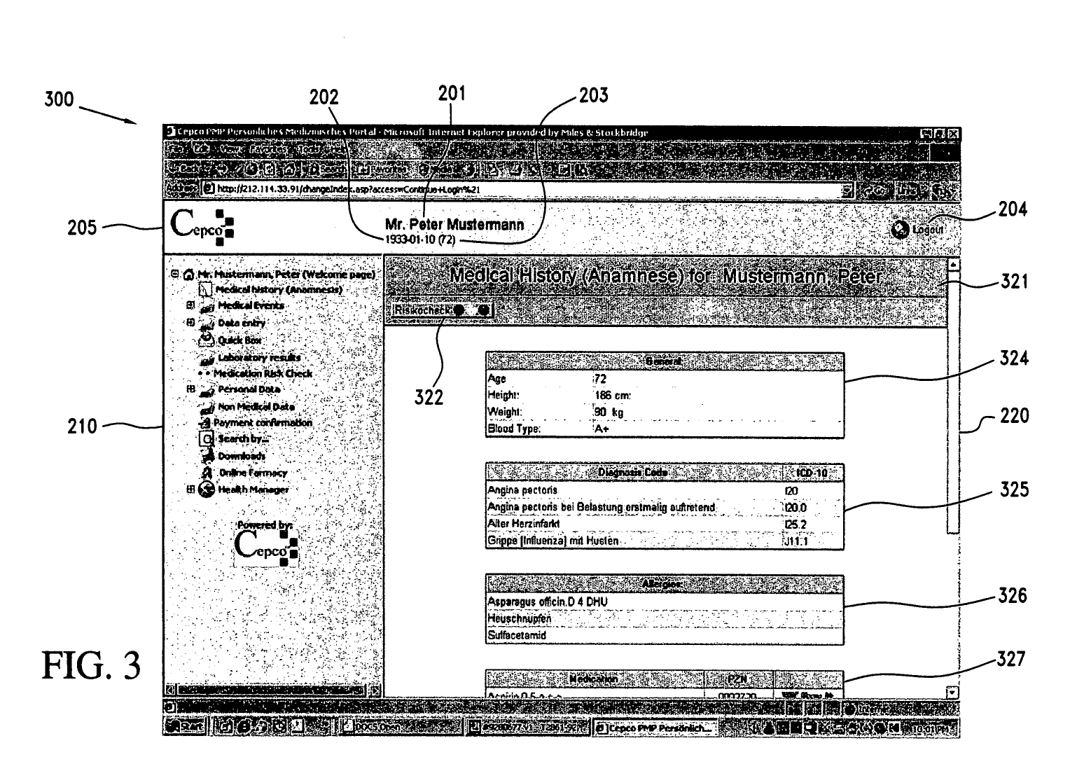

FIG. 3 is a screen shot of a medical history (Anamnesis) page 300 of the web-based implementation of the PMP, in accordance with one or more embodiments of the present invention. In FIG. 3 and subsequent FIGS., reference numbers may be re-used from previous FIGs to designate and describe like elements without further description. Lower right section 220, in FIG. 3, may provide details on the patient's medical history and may include an information type message section 321, here identifying the medical data as belonging to Mr. Peter Mustermann. In addition, information type message section 321 may include a medication incompatibility test (Risikocheck) radio button and/or icon 322 to check the patient's risk for adverse consequences from the listed medical conditions in the medical history. Also included in lower right section 220 may be a general information box 324 (e.g., age, height, weight, blood type, etc.); a diagnosis code box 325 with the patient's diagnosis history including ICD-10 name and code; an allergies box 326 to list all the patient's food, plant, and drug allergies; and a medications box 327 to list all medications that the patient is currently taking and has previously taken. Not shown is a box for vaccinations that may list the vaccination record for the patient. The patient, i.e., the owner, of the Portal, is the only person who may manage general data about the patient. There, the patient may enter or actualize registered data, separated by Registration Details, Contact Information, (statistical) medical data (Age, Sex, Height are static data, while Weight is dynamic data), emergency information and health insurance (HMO). In general, medical history (Anamnesis) page 300 is designed as a display only page and changes to specific information provided on the page automatically enter the Anamnesis sheet once new data enters the portal or old data are amended or updated.

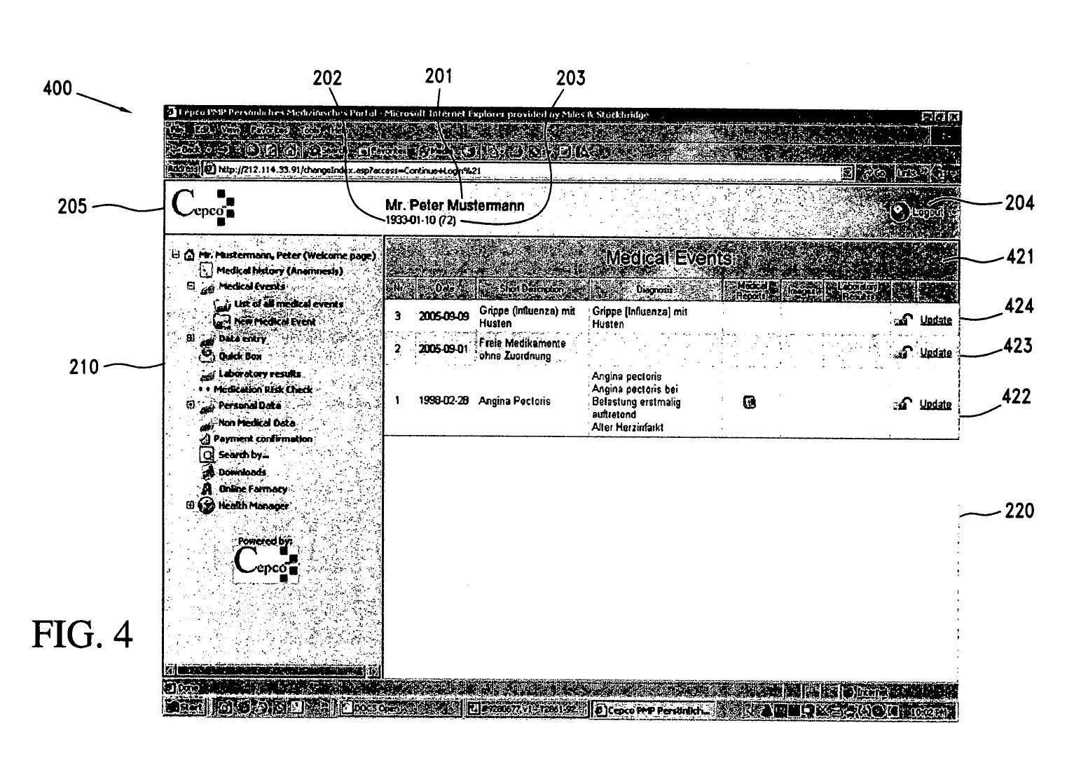

FIG. 4 is a screen shot of a summary medical events page 400 of the web-based implementation of the PMP, in accordance with one or more embodiments of the present invention. In FIG. 4, lower right section 220 may include a medical events header 421 to identify the subsequent information as medical events 1, 2 and 3, which are identified by 422, 423, 424, respectively, that the patient has had. Associated with each medical event is a number, a date of the event, a short description of the event, a diagnosis, any associated medical reports, any associated images, any associated laboratory results, a lock/unlock button that allows the patient to close a medical event for viewing while it does not affect the viewing-options at any other medical event (the tool enables the patient to hide or block information from third parties while keeping other information open to review); and an update column with a link to the data associated with that event that may be selected to edit the information associated with the event.

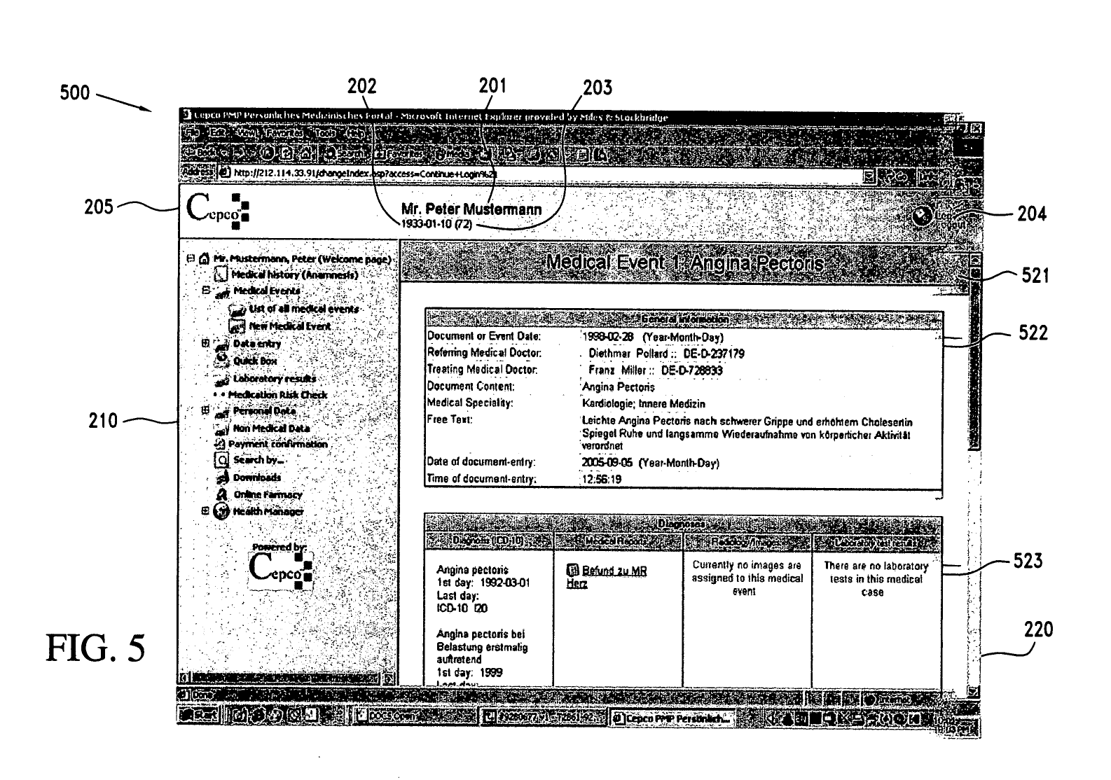

FIG. 5 is a screen shot of a detailed medical events page for “Medical Event 1: Angina Pectoris” 500 listed in FIG. 4 of the web-based implementation of the PMP, in accordance with one or more embodiments of the present invention. In FIG. 5, lower right section 220 may include a medical event number header 521 to identify the subsequent information being related to medical event 1 with a general information box 522 to identify an event date, a referring medical doctor, a treating medical doctor, a document content, a medical specialty, free text for notes, a date the information was entered, and the time the data was entered. Lower right section 220 may also include a diagnoses box 523 that has an events diagnosis (ICD-10) code column, a medical reports links column, a radiology/images column, and a laboratory test results column.

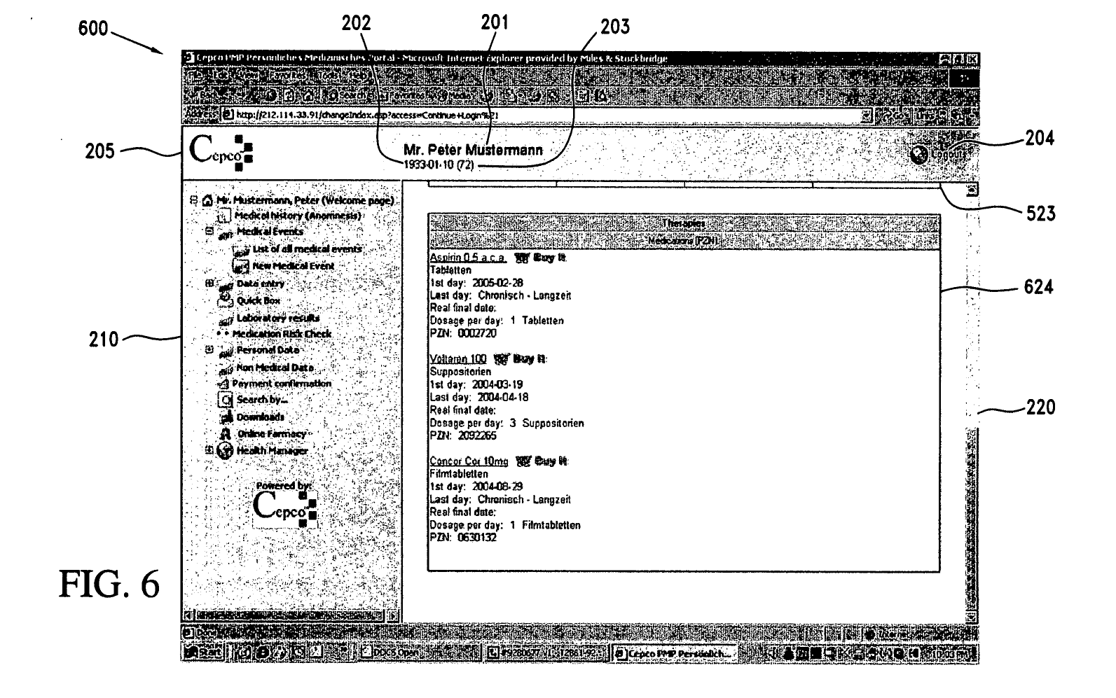

FIG. 6 is a screen shot of a bottom portion of the detailed medical events page 500 for event 1 shown in FIG. 5 of the web-based implementation of the PMP, in accordance with one or more embodiments of the present invention. In FIG. 6, lower right section 220 may further include a therapies box 624 listing the medications that have been prescribed for the patient. A bottom portion of diagnoses box 523 may be seen at the top of lower right section 220 above therapies box 624. The information that may be provided may include the name and dosage weight of the medication, a type of the medication (e.g., tablet, liquid, etc.), a prescribed start and end dates, a real end date, a daily dosage, and a prescription number. Associated with the medications name is a shopping cart icon with a label “buy it,” which may provide an interface to Internet pharmacy 114 and/or e-prescription system 118.

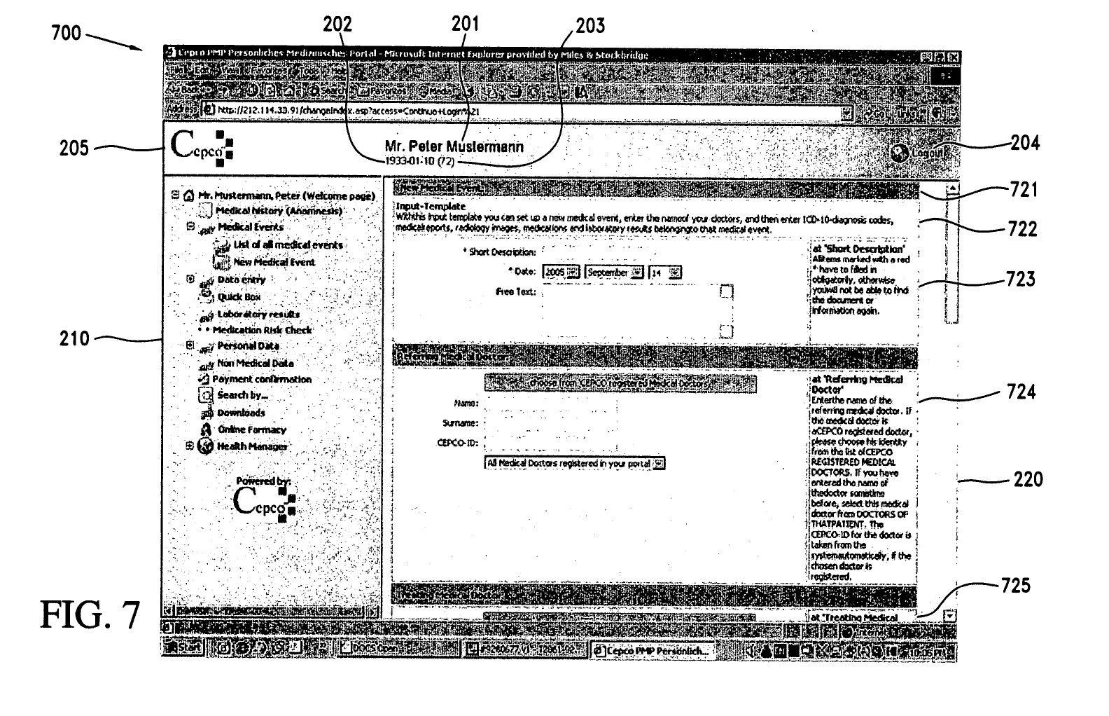

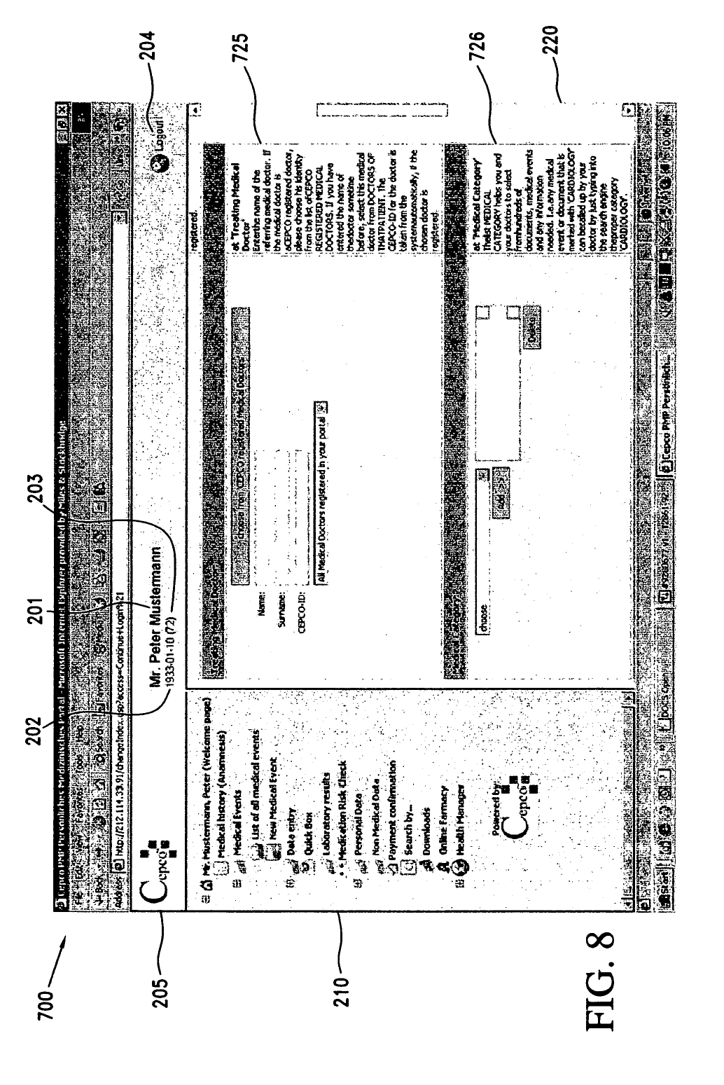

FIG. 7 is a screen shot of a new medical events page 700 of the web-based implementation of the PMP, in accordance with one or more embodiments of the present invention. In FIG. 7, lower right section 220 may include a new medical event banner 721, a new input-template information box 722, a short description box 723 for entering a short description of the medical event, and a referring medical doctor box 724 for entering the name and identification of the referring doctor. In addition, the top of a treating medical doctor box 725 may be seen, but will be described below in relation to FIG. 8.

FIG. 8 is a screen shot of a next-lower section of the new medical events page 700 of FIG. 7, in accordance with one or more embodiments of the present invention. In FIG. 8, lower right section 220 may further include the treating medical doctor box 725 for entering the name and identification information of the treating doctor, and a medical category box 722 for entering with which category the medical should be associated, for example, cardiology, oncology, etc.

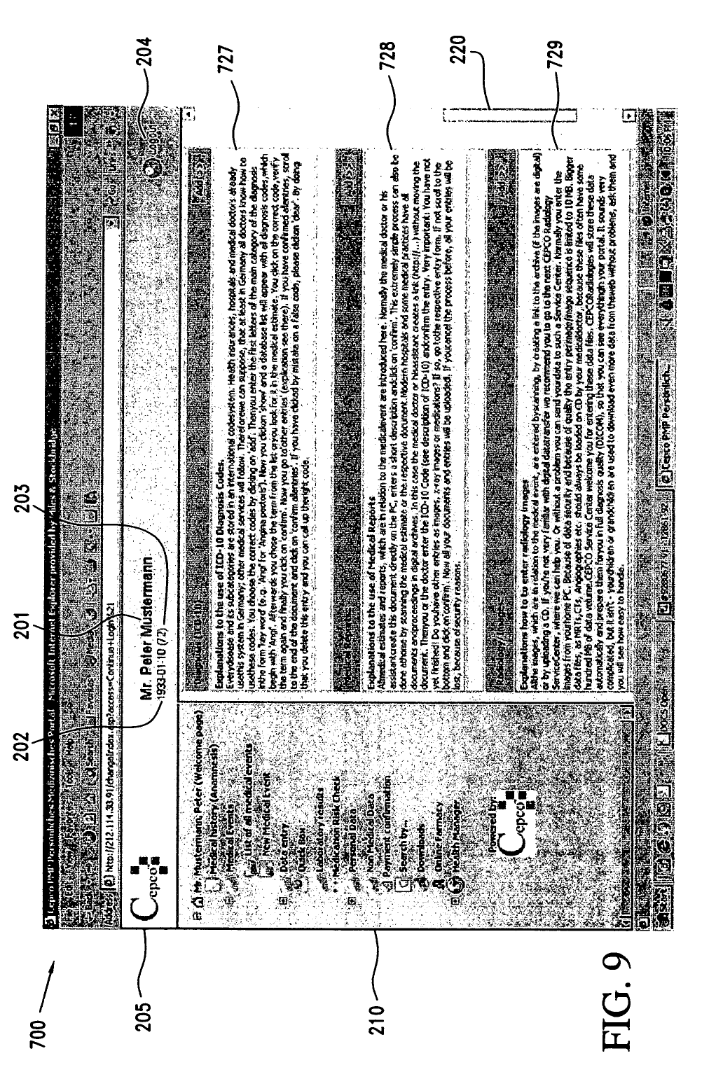

FIG. 9 is a screen shot of a still next-lower section of the new medical events page 700 of FIGS. 7 and 8, in accordance with one or more embodiments of the present invention. In FIG. 9, lower right section 220 may further include a diagnosis (ICD-10) box 727 for selecting which ICD-10 diagnosis codes should be applied to the medical event, a medical reports box 728 for entering reports and other information prepared by the treating doctor, and a radiology/images box 729 for linking, uploading, etc. radiology and other image data.

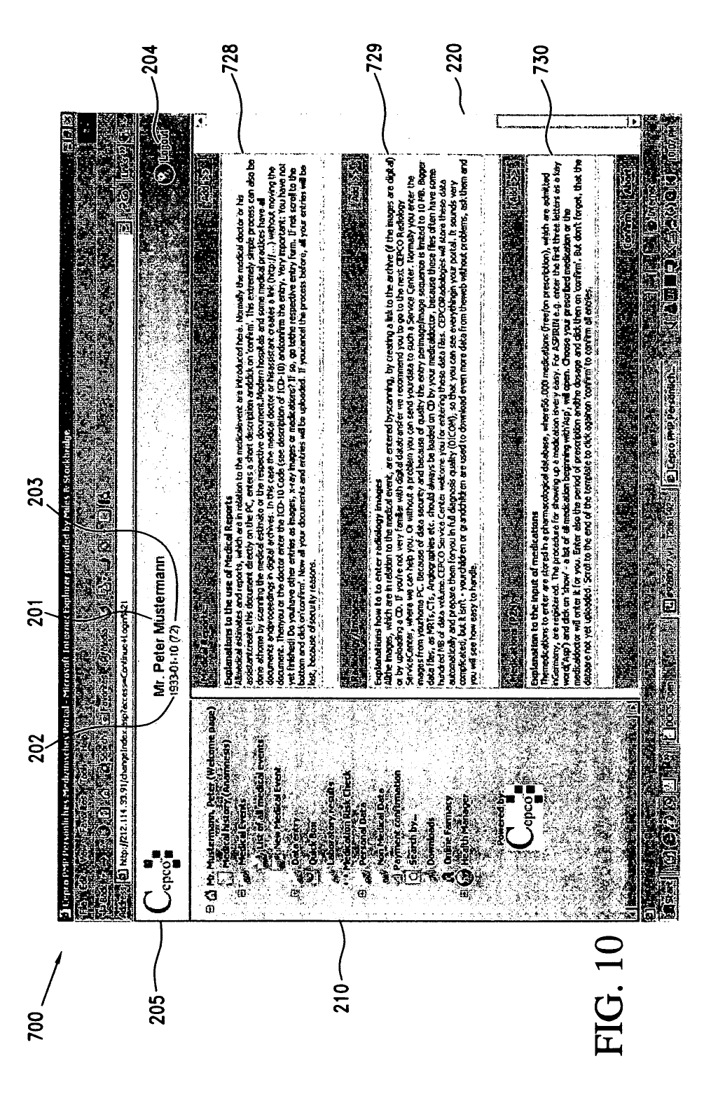

FIG. 10 is a screen shot of a bottom-most section of the new medical events page 700 of FIGS. 7-9, in accordance with one or more embodiments of the present invention. In FIG. 10, lower right section 220 may further include a medications box 725 for entering, linking, etc. and a list of medications that the patient is and/or has taken.

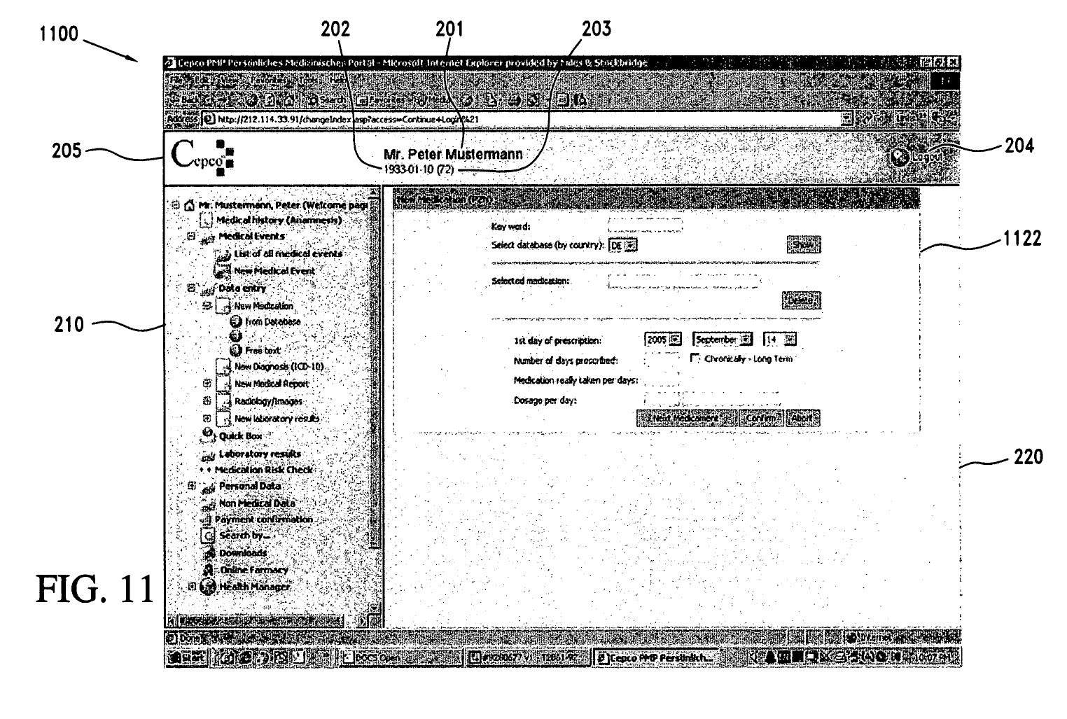

FIG. 11 is a screen shot of a medication data input page 1100 of the web-based implementation of the PMP, in accordance with one or more embodiments of the present invention. In FIG. 1, lower right section 220 may include a new medication data input box 1122 for entering information on a new medication using a keyword to access a pharmaceutical database to retrieve the selected medication and an area to enter some of the information displayed above in FIG. 6, for example, prescribed start date, a number of days prescribed, how many days the medication was actually taken, a daily dosage, confirm and abort buttons to add or not add the medication to the patient's PMP and a next medication button to add another medication. In addition to the above semi-manual data input, the data on the medication may be totally entered manually, and/or received/entered from an electronic prescription.

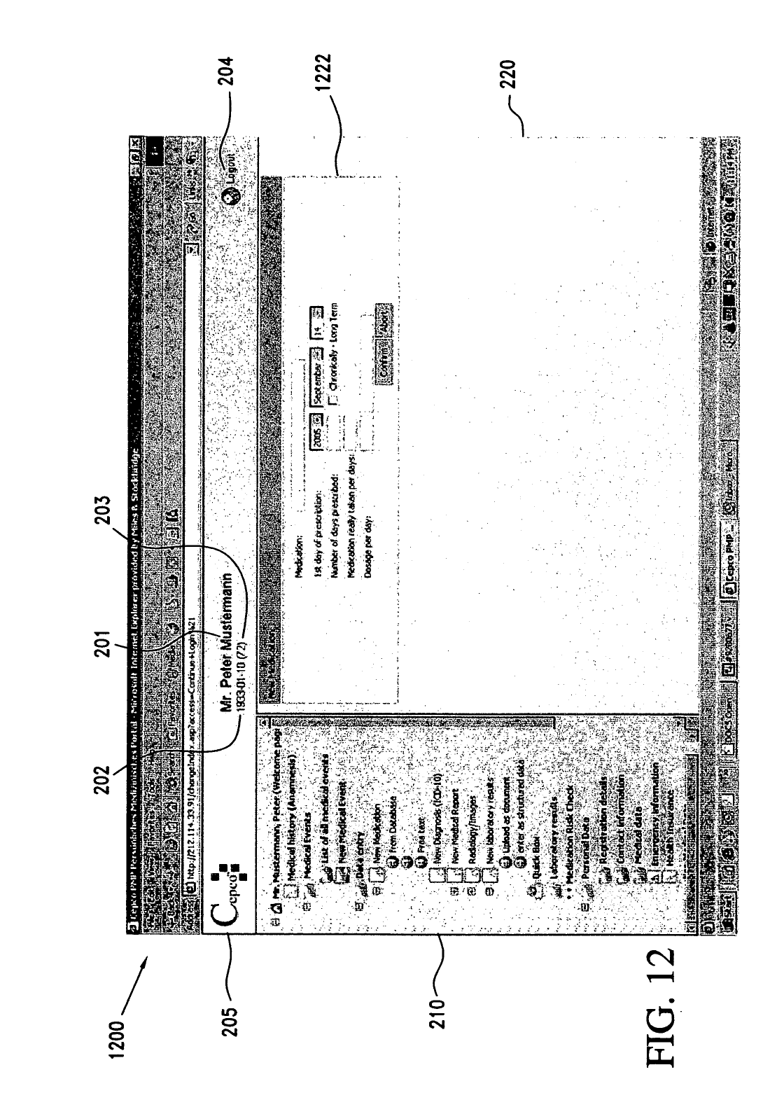

FIG. 12 is a screen shot of a new medication page 1200 of the web-based implementation of the PMP, in accordance with one or more embodiments of the present invention. In FIG. 12, lower right section 220 may include a new medication input box 822 for entering information on the new medication, including, for example, the name of the medication, a first day of the prescription, a number of days prescribed, a number of days that the medication was actually taken, and a daily dosage.

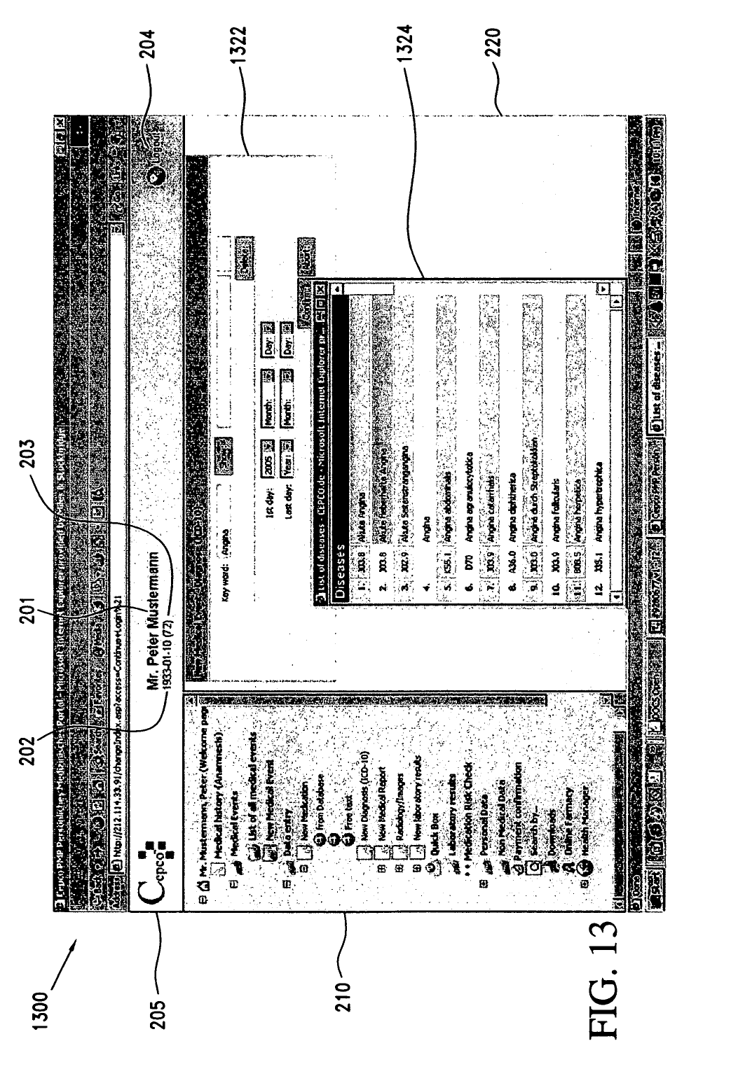

FIG. 13 is a screen shot of a new medical event diagnostic code (ICD-10) data input page 1300 of the web-based implementation of the PMP, in accordance with one or more embodiments of the present invention. In FIG. 13, lower right section 220 may include a new medical event diagnostic ICD-10 code input box 1322 for entering information on a new medical condition using a keyword, for example, angina, to access a disease database, for example, the World Health Organization (WHO) Disease database. Lower right section 220 may also include a pop-up window 1324, which lists the diseases returned from the database in response to the keyword, for example, all diseases with angina in their names.

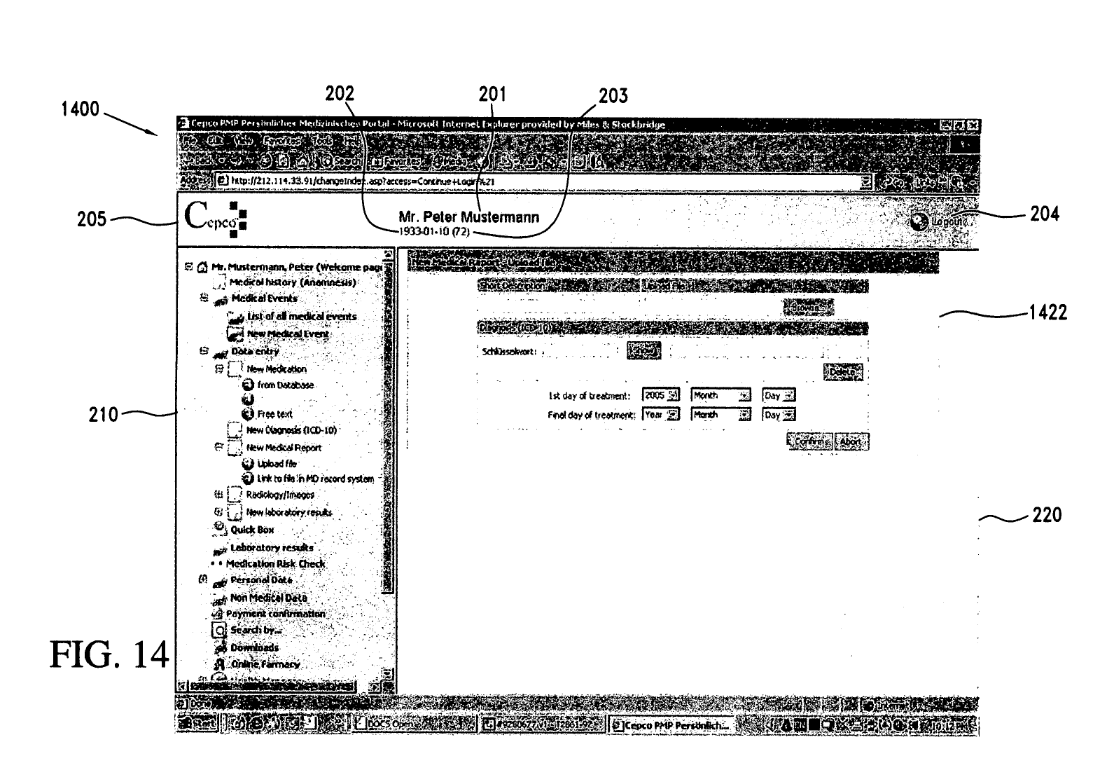

FIG. 14 is a screen shot of a new medical report file upload page 1400 of the web-based implementation of the PMP, in accordance with one or more embodiments of the present invention. In FIG. 14, lower right section 220 may include an upload file input box 1422 in which a short description and a new medical event diagnostic ICD-10 code may be entered for the uploaded file.

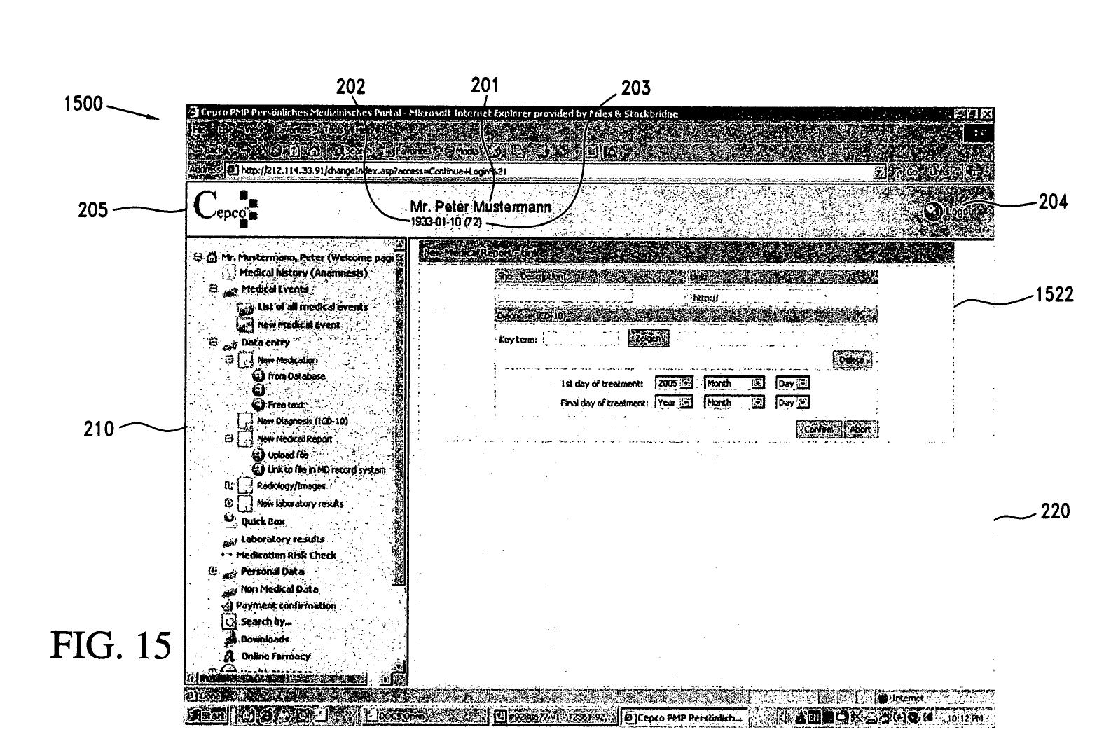

FIG. 15 is a screen shot of a new medical report file link page 1500 of the web-based implementation of the PMP, in accordance with one or more embodiments of the present invention. Similar to FIG. 14, in FIG. 15, lower right section 220 may include a link file input box 1522 in which a short description and a new medical event diagnostic ICD-10 code may be entered for the linked file.

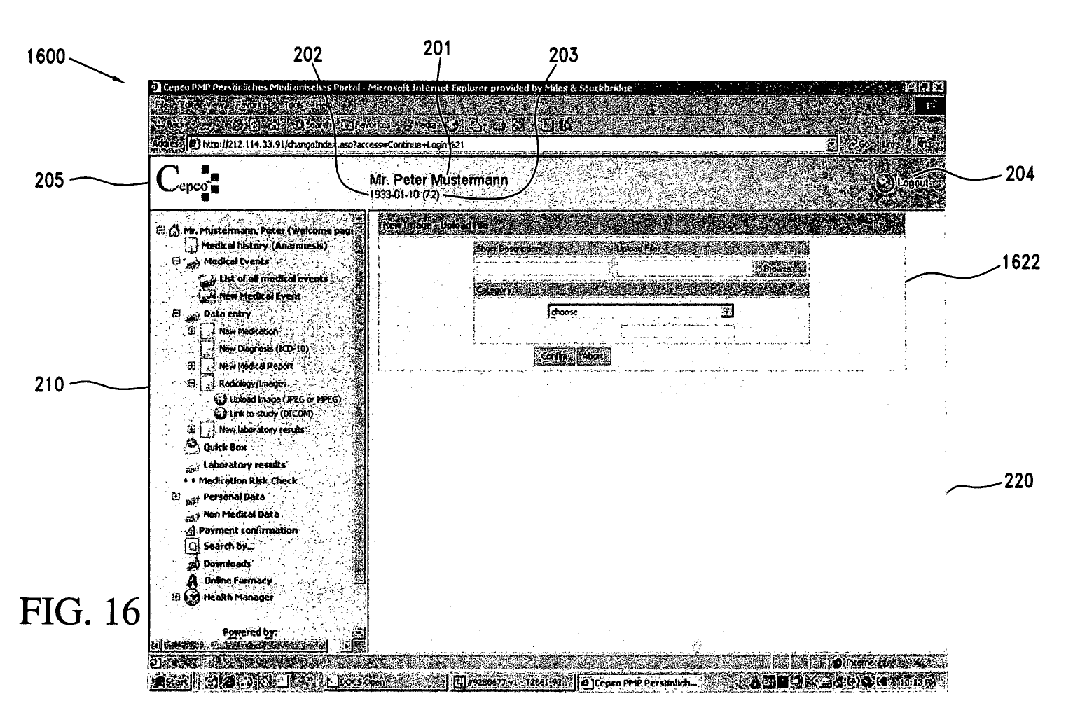

FIG. 16 is a screen shot of a new image file upload page 1600 of the web-based implementation of the PMP, in accordance with one or more embodiments of the present invention. In FIG. 16, lower right section 220 may include an upload image input box 1622 in which a short description and a category, for example, X-ray, photograph, etc., may be selected for the uploaded image.

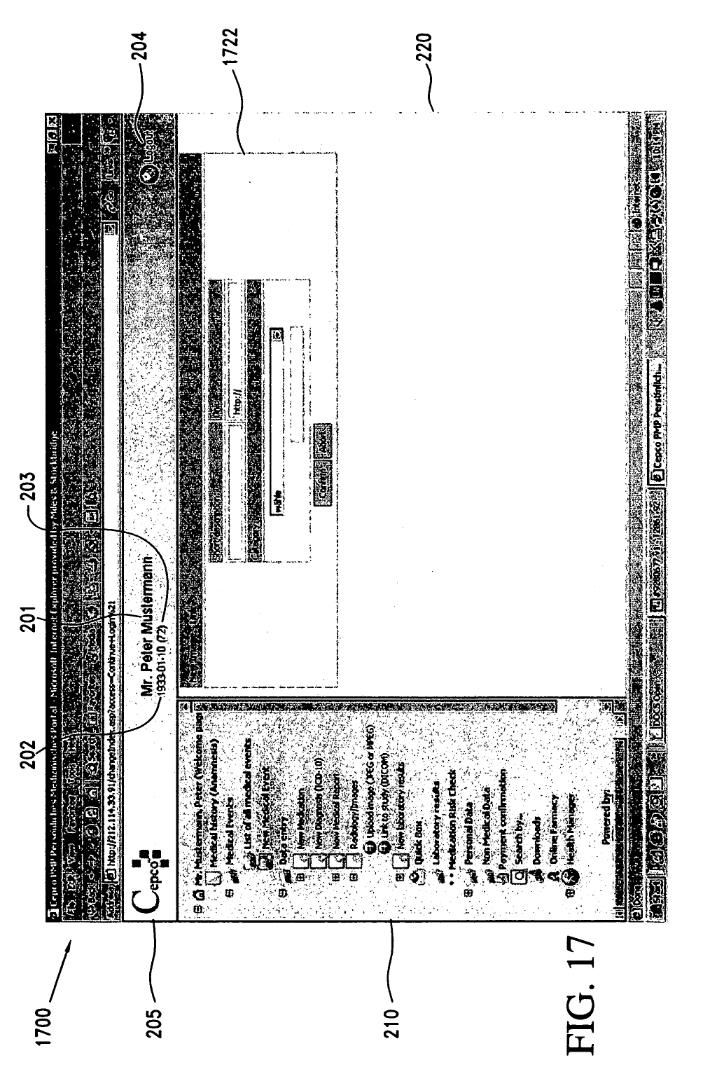

FIG. 17 is a screen shot of a new image link page 1700 of the web-based implementation of the PMP, in accordance with one or more embodiments of the present invention. Similar to FIG. 16, in FIG. 17, lower right section 220 may include a link image input box 1722 in which a short description and a category, for example, X-ray, photograph, etc., may be selected for the linked image.

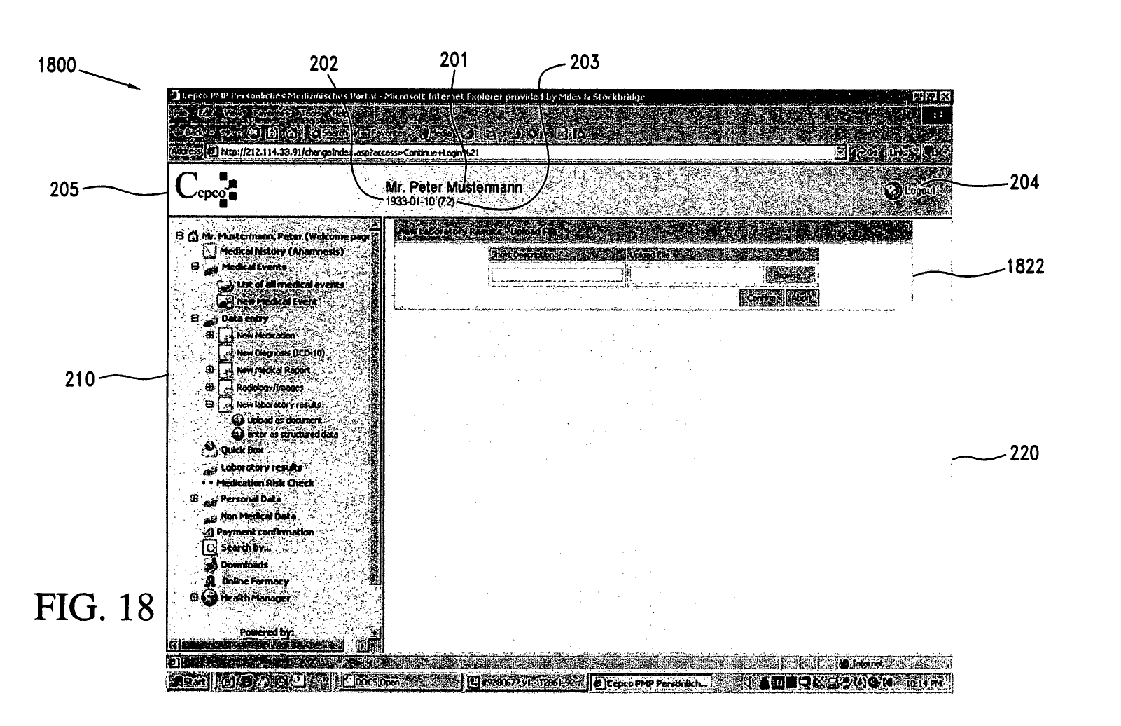

FIG. 18 is a screen shot of a new image file upload page 1800 of the web-based implementation of the PMP, in accordance with one or more embodiments of the present invention. In FIG. 18, lower right section 220 may include an upload image input box 1822 in which a short description may be selected for the uploaded file.

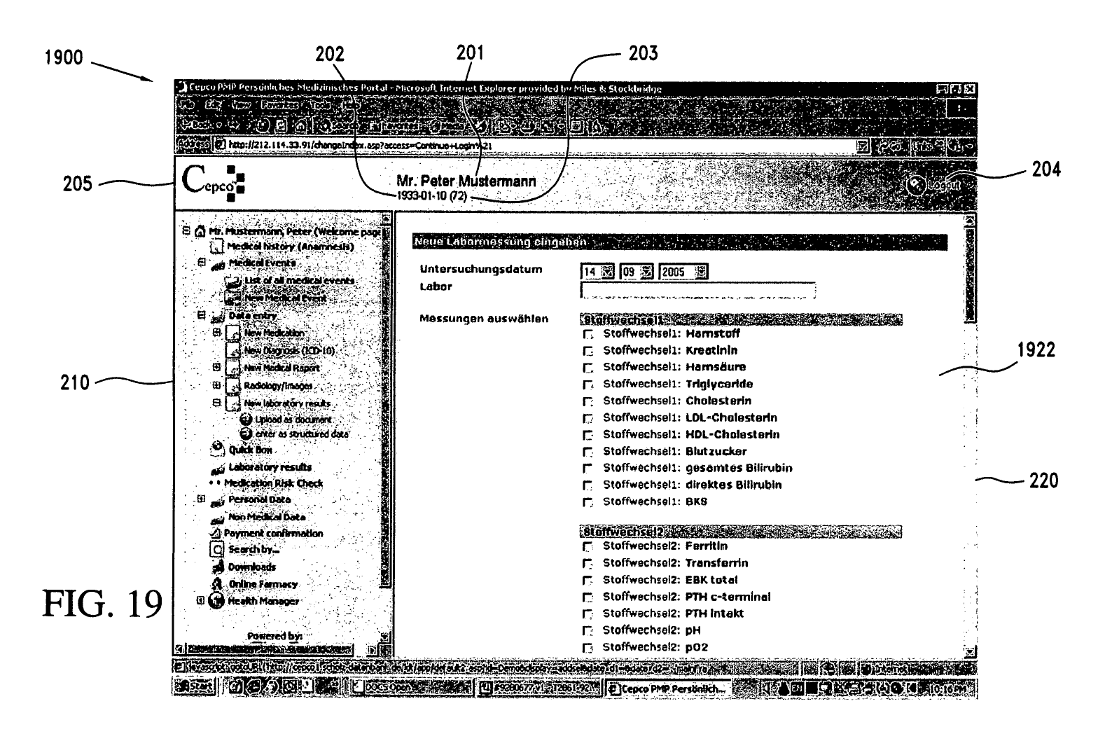

FIG. 19 is a screen shot of a laboratory results data input page 1900 of the web-based implementation of the PMP, in accordance with one or more embodiments of the present invention. In FIG. 19, lower right section 220 may include a new laboratory results box 1922 in which new laboratory results may be entered by uploading a scanned, faxed, and/or emailed lab report; or by entering, either manually or automatically through an interface, the lab report information as structured data.

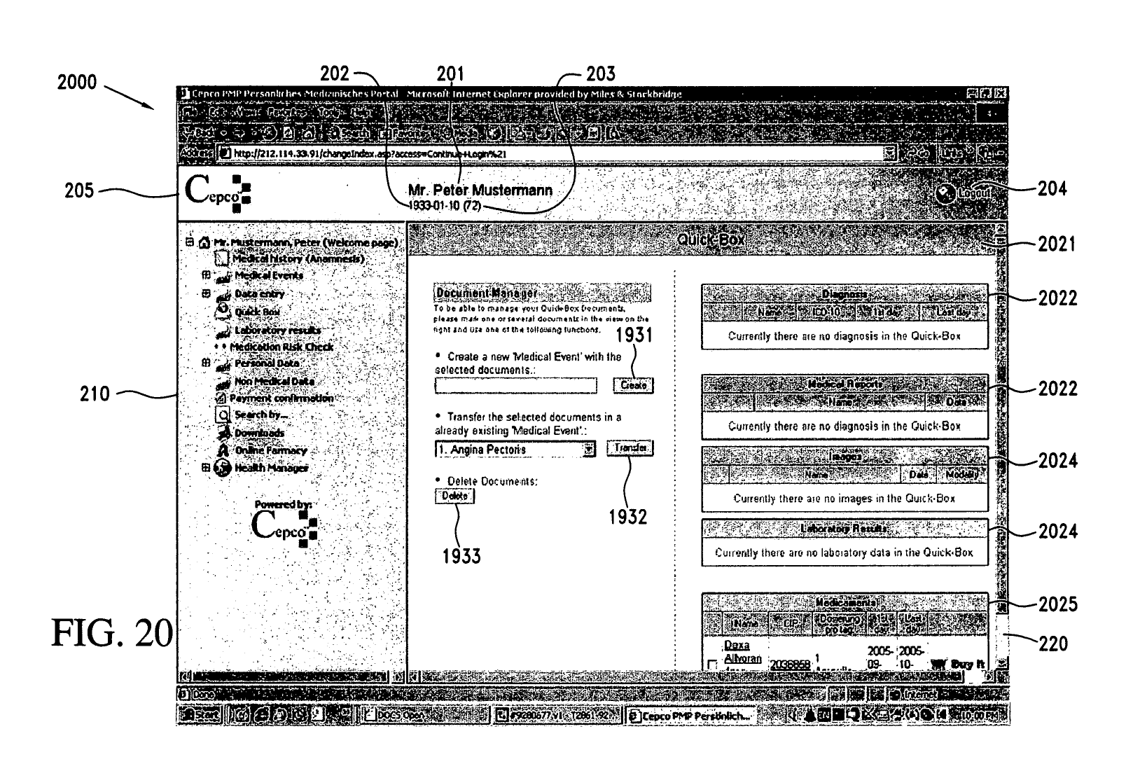

FIG. 20 is a screen shot of a quick box page 2000 of the web-based implementation of the PMP, in accordance with one or more embodiments of the present invention. In FIG. 20, lower right section 220 may include a quick box banner 2021, a diagnosis box 2022 that may display current diagnoses available in the quick box, a medical reports box 2023 that may display current medical reports available in the quick box, an images box 2024 that may display current images available in the quick box, a laboratory results box 2022 that may display current laboratory results available in the quick box, and a medicaments (medicines) box 2025 that may display a list of prescribed medicaments available in the quick box.

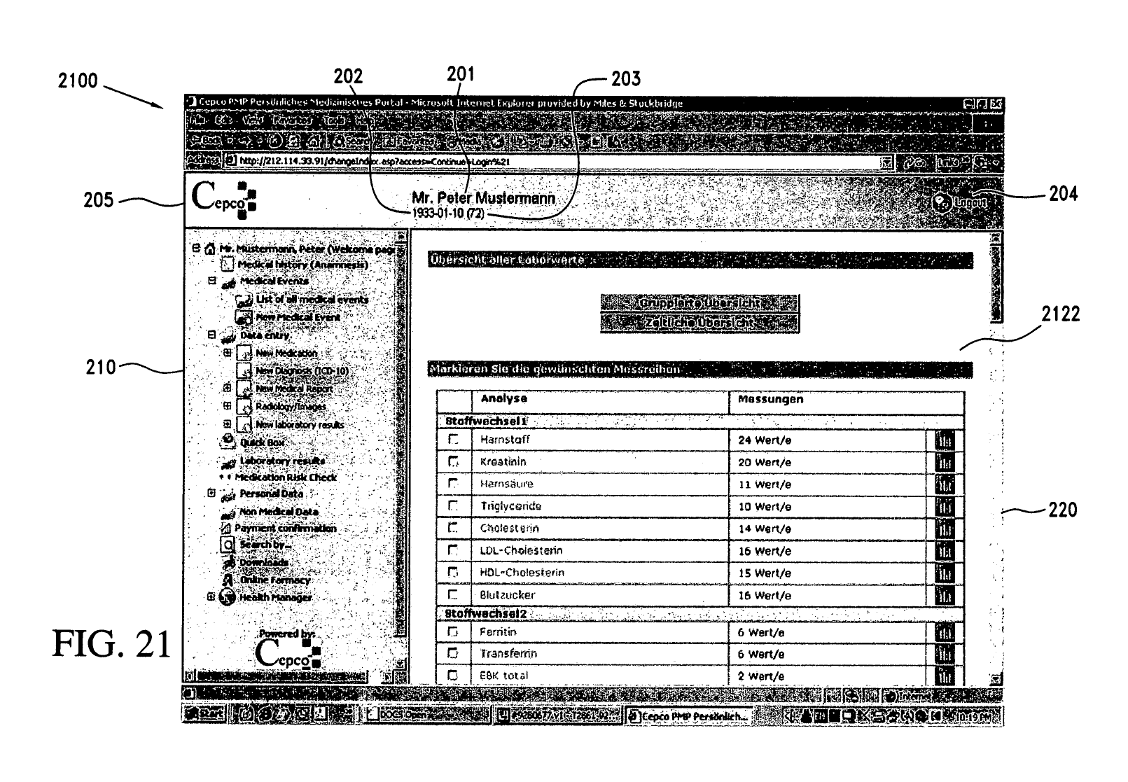

FIG. 21 is a screen shot of a laboratory results page 2100 of the web-based implementation of the PMP, in accordance with one or more embodiments of the present invention. In FIG. 21, lower right section 220 may include a laboratory results box 2122 that may display a cumulative summary of all of the patient's laboratory test results for each specific test (Analyse), provide information on how many results are available for each specific test (Messungen), and an image icon to graphically display the results for each specific test.

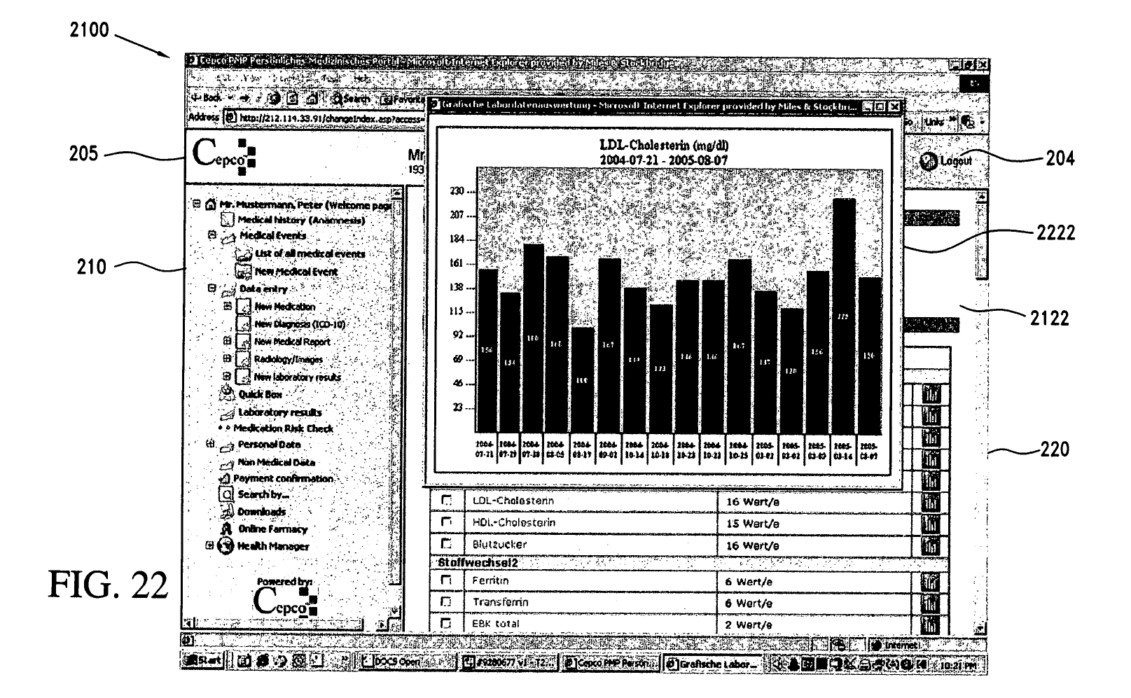

FIG. 22 is a screen shot of a laboratory results page 2100 of the web-based implementation of FIG. 21, in accordance with one or more embodiments of the present invention. In FIG. 22, a graphic display box 2222 has been overlaid on laboratory results page 2100 and displays the patient's cumulative LDL-Cholesterol test results from Jul. 21, 2004 to Aug. 7, 2005.

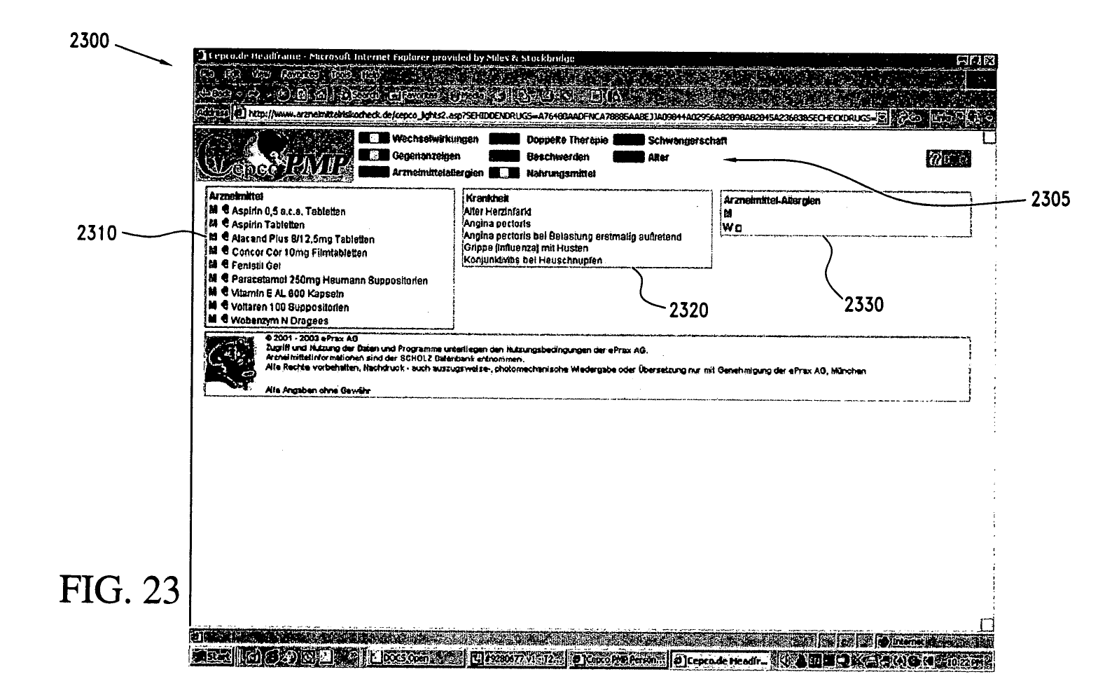

FIG. 23 is a screen shot of a medication risk check page 2300 of the web-based implementation of FIG. 23, in accordance with one or more embodiments of the present invention. In FIG. 23, medication risk check page 2300 may include a risk level area 2305 that may provide a color-coded listing of risk levels, a box 2310 that may contains all the patient's medications, ICD-10 codes and laboratory results, a medication-information box 2320 that may gives the patient and his prescribing MD all pharmacological information whilst prescribing that medication, and a price-comparison of said medication to all other synonym medications registered in any specific national pharmacological database box 2330 that may offer the MD and his (paying) patient the most cost-efficient medication with identical or similar pharmacological effect.

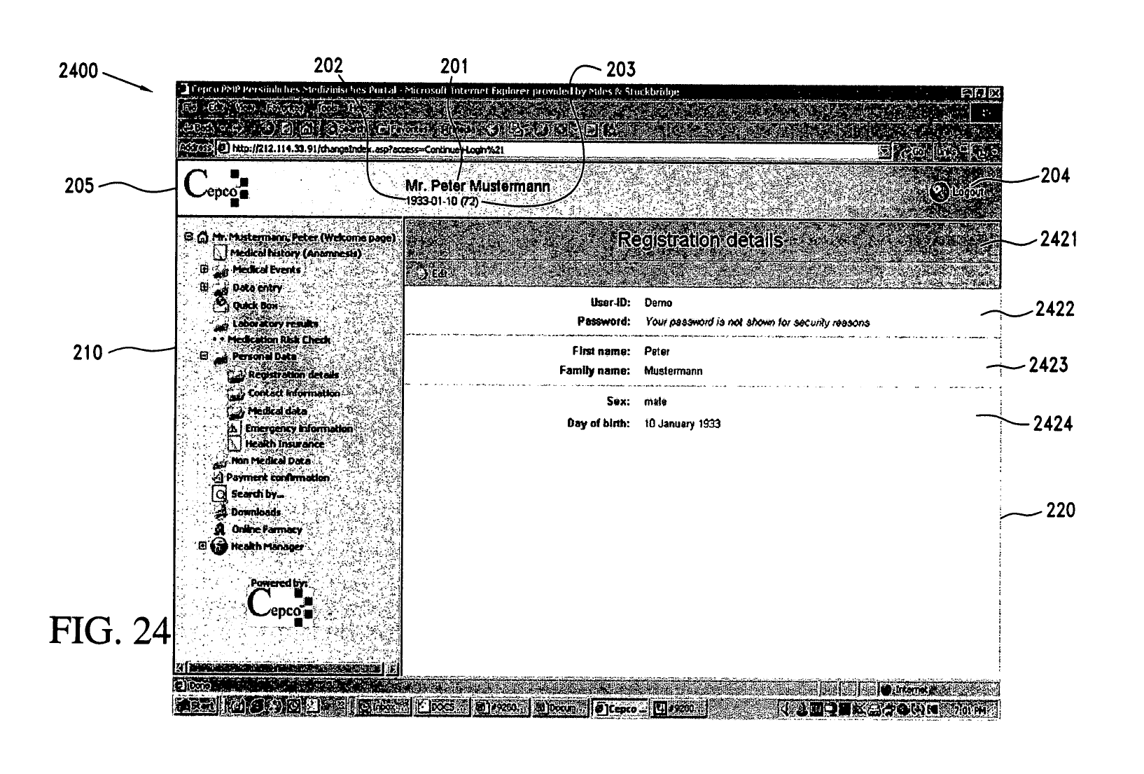

FIG. 24 is a screen shot of a registration details page 2400 of the web-based implementation of the PMP, in accordance with one or more embodiments of the present invention. In FIG. 24, lower right section 220 may include a registration details banner 2421, a user information box 2422 that may display the patient's user-ID and hidden password, a patient name box 2423 that may display the patient's first, last, etc. names, and a vital statistics box 2424 that may display the sex, birthday and/or other identifying details (e.g., hair color, eye color, etc.) about the patient.

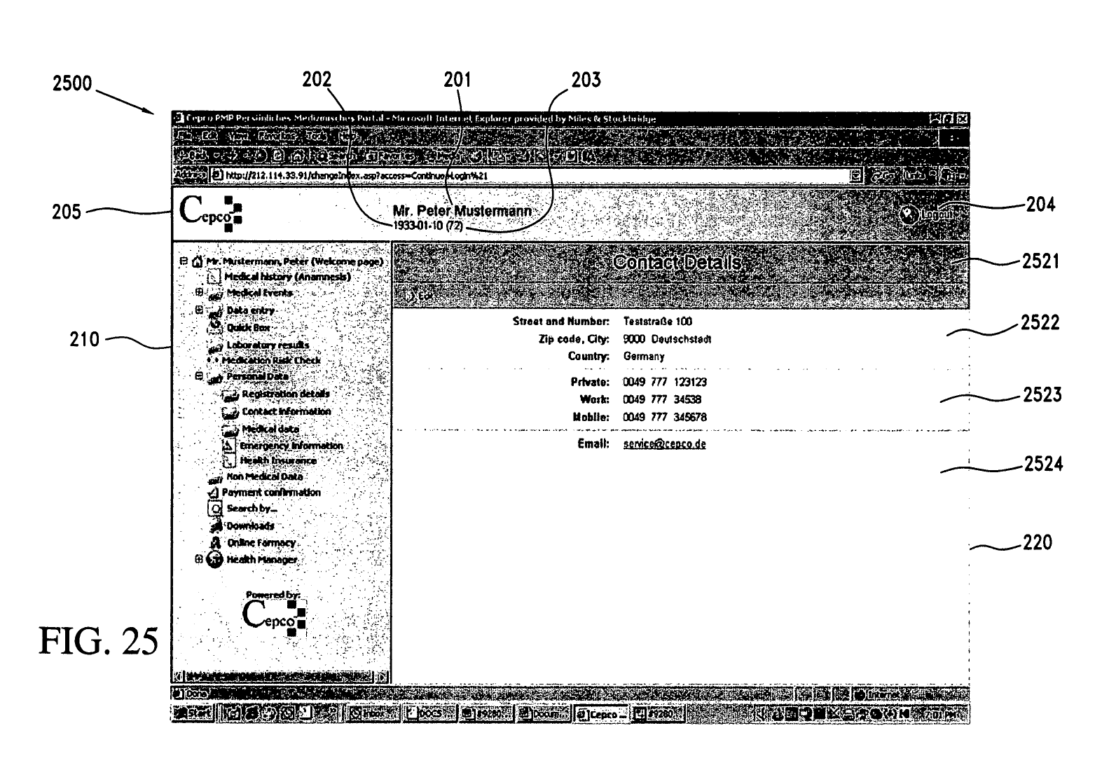

FIG. 25 is a screen shot of a contact details page 2500 of the web-based implementation of the PMP, in accordance with one or more embodiments of the present invention. In FIG. 25, lower right section 220 may include a contact details banner 2521, an address information box 2422 that may display the patient's home address including, street, city, state, zip and country; a telephone number box 2523 that may display the patient's home, cell and work telephones; and an email box 2524 that may display the patient's email address.

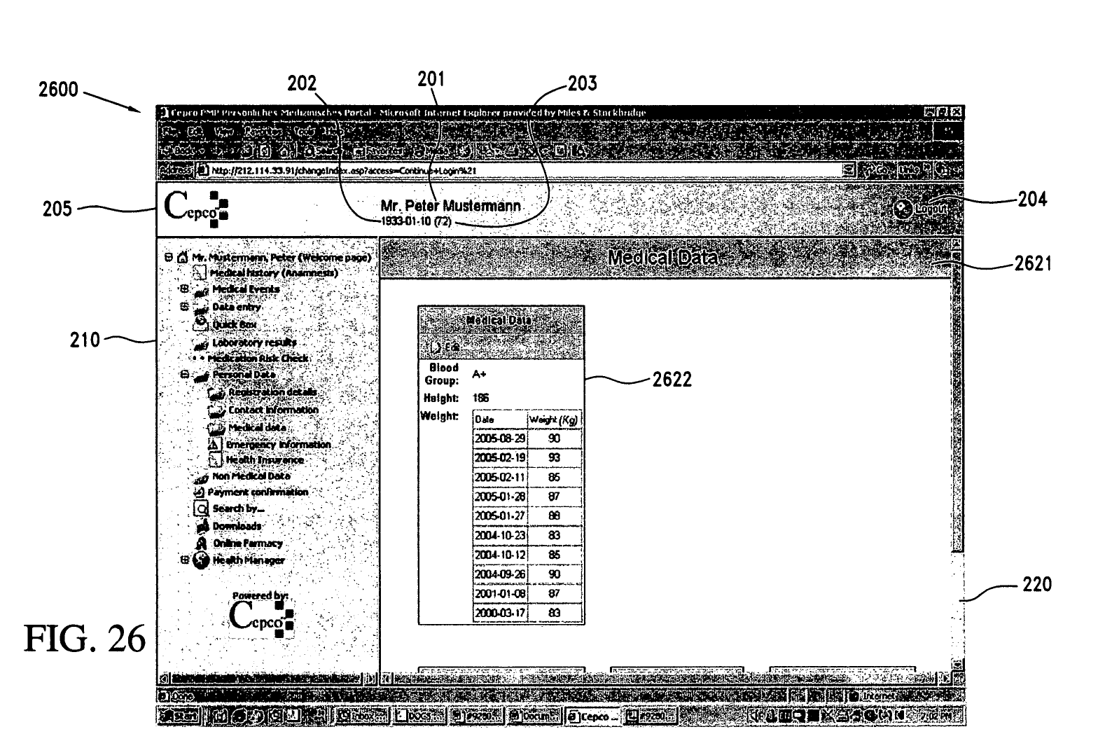

FIG. 26 is a screen shot of a medical data page 2600 of the web-based implementation of the PMP, in accordance with one or more embodiments of the present invention. In FIG. 26, lower right section 220 may include a medical data banner 2621, and a medical data box 2622 that may display the patient's blood type, height, and weight. Although only the weight information is provided over time, the height information may also be similarly maintained, especially for younger and older patients who may be growing and shrinking, respectively.

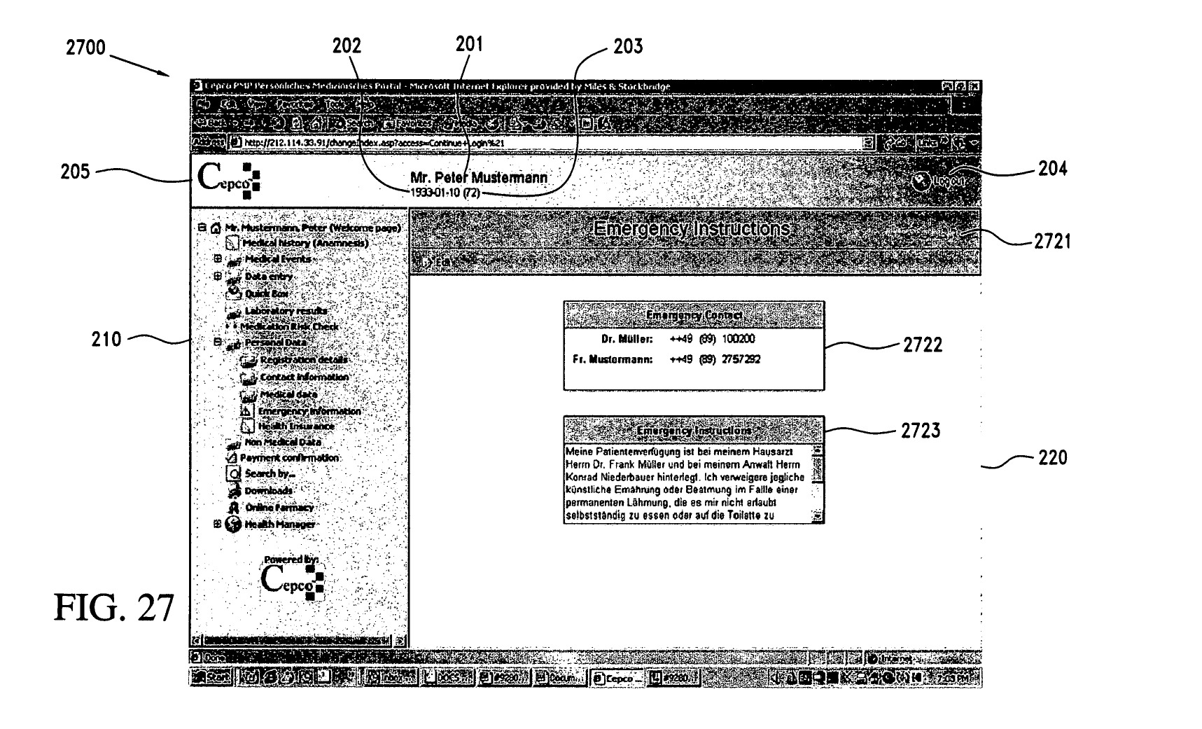

FIG. 27 is a screen shot of an emergency instructions page 2700 of the web-based implementation of the PMP, in accordance with one or more embodiments of the present invention. In FIG. 27, lower right section 220 may include an emergency instructions banner 2721, an emergency contact box 2722 that may display the patient's doctors and their telephone numbers, and an emergency instructions box 2723 that may display specific instructions that are to be followed in case of an emergency with the patient.

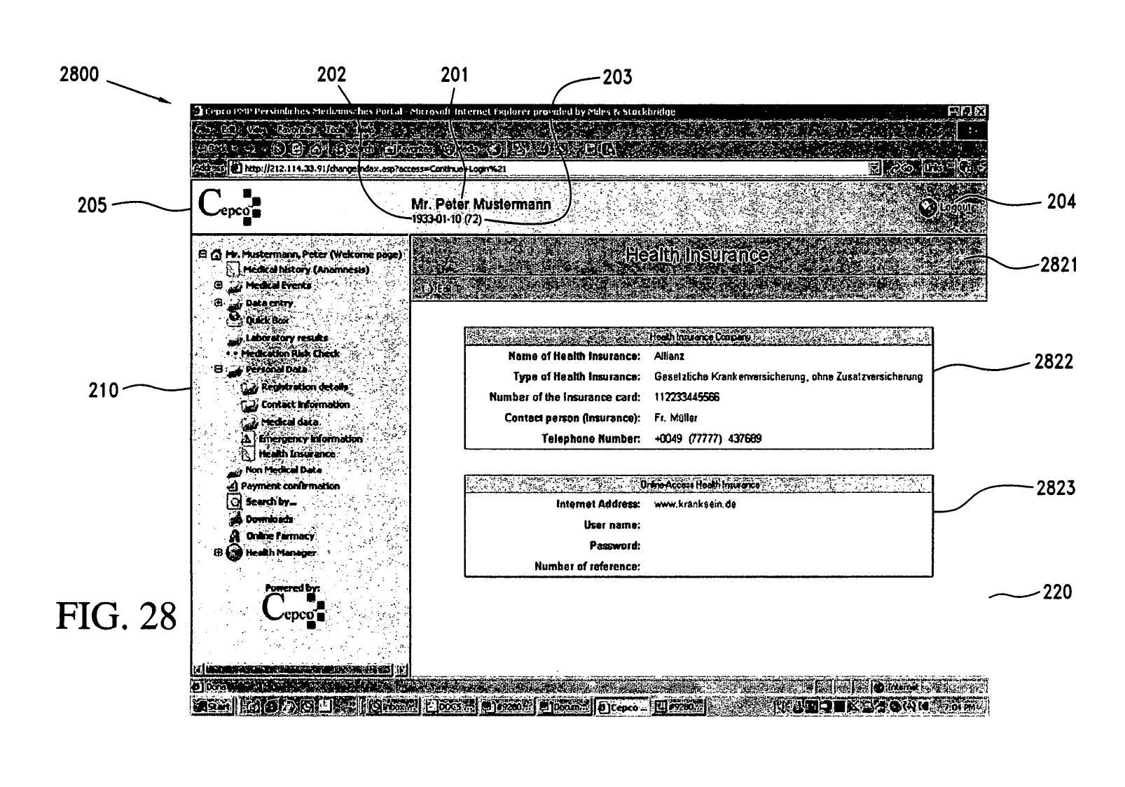

FIG. 28 is a screen shot of a health insurance page 2800 of the web-based implementation of the PMP, in accordance with one or more embodiments of the present invention. In FIG. 28, lower right section 220 may include a health insurance banner 2821, a health insurance company box 2822 that may display the patient's health insurance information (insurance company, type of insurance, policy number, group number, member number, etc.), and an online access box 2823 that may display specific information and/or instructions (insurance company Internet address, patient's user name and password, etc.) for accessing the patient's health insurance information via the Internet.

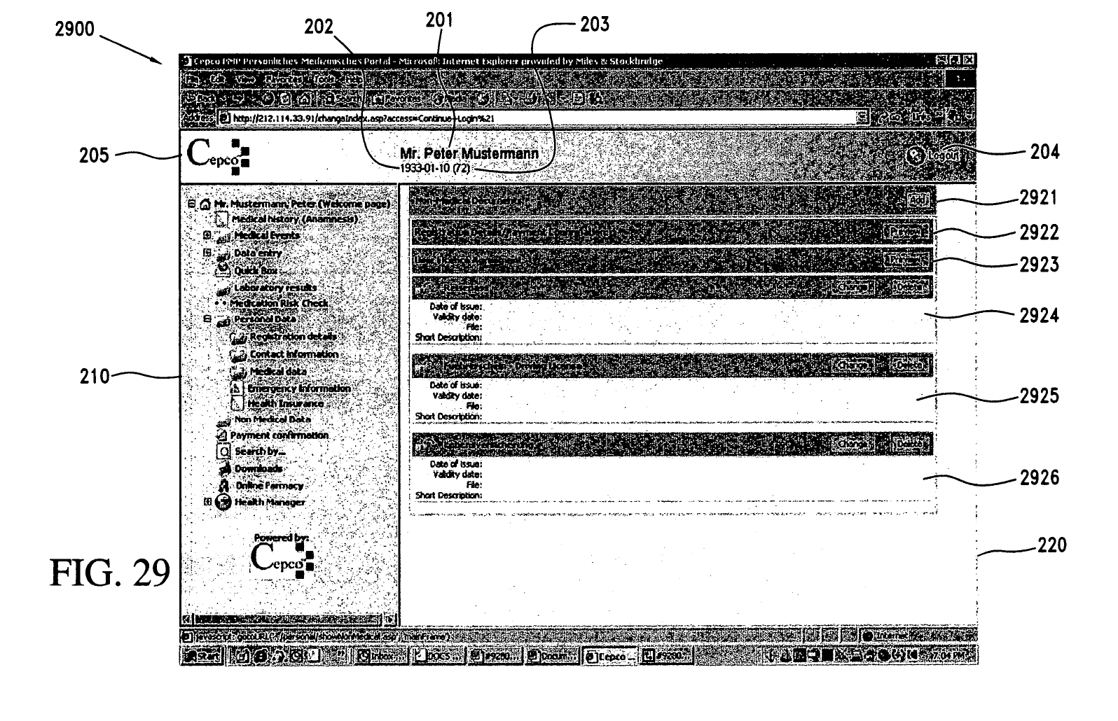

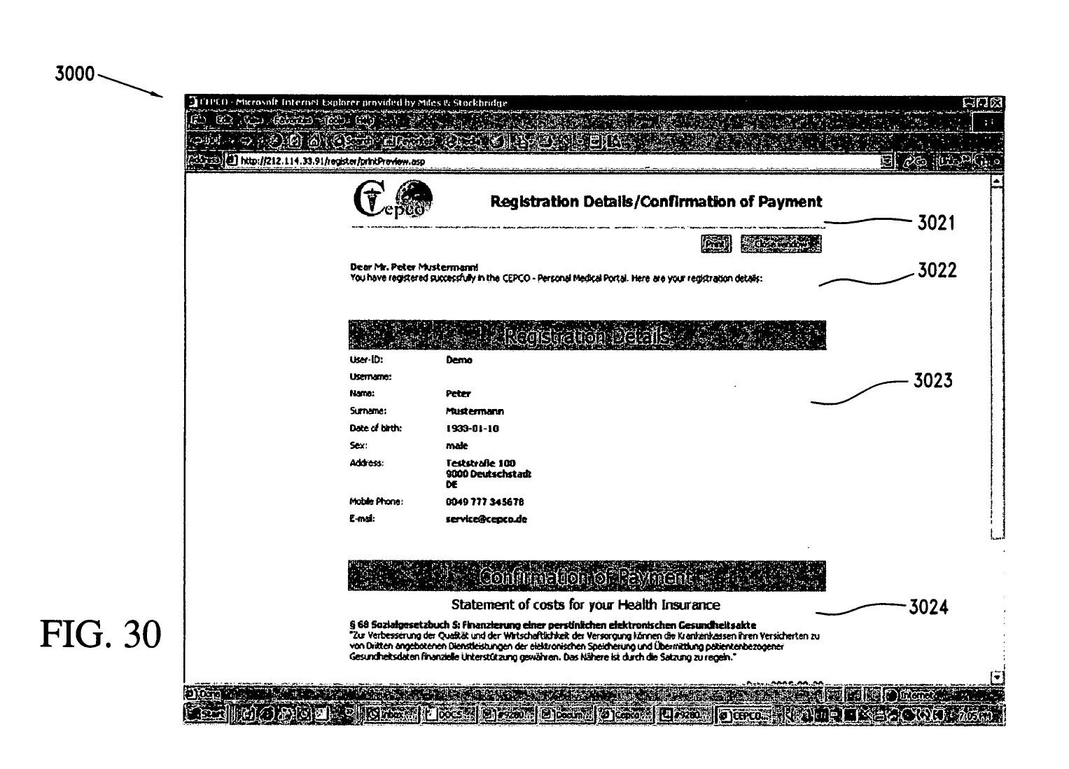

FIG. 29 is a screen shot of a non-medical documents page 2900 of the web-based implementation of the PMP, in accordance with one or more embodiments of the present invention. In FIG. 29, lower right section 220 may include a non-medical documents banner 2921 with an add button for adding new non-medical documents to the patient's PMP, a registration details/payment confirmation box 2922 with a preview button that may display details of the patient's registration and payment history (see FIG. 30), a user license agreement box 2923 with a preview button that may display details of the user license agreement the user agreed to when registering for to use the PMP system, a Passport (Reisepass) box 2924 that may display the scanned in pages of your national passport for identification in case of loss, a driving license box 2925 that may display the patient's driving license information, and a copy of your Life-Insurance (Lebensversicherung) or any other insurance for that purpose that may display all your insurance details. FIG. 30 is a screen shot of a registration details/payment confirmation page 3000 of the web-based implementation of the PMP, in accordance with one or more embodiments of the present invention. In FIG. 30, lower right section 220 may include a registration details/payment confirmation banner 3021 with a print button and a close window button, a registration confirmation message box 3022 with a message indicating whether the patient has successfully registered, a registration details box 3023 that may display the necessary details about the user that were needed to register to use the PMP system, and a confirmation of payment box 3024 that may display a statement of costs for the patient's health insurance.

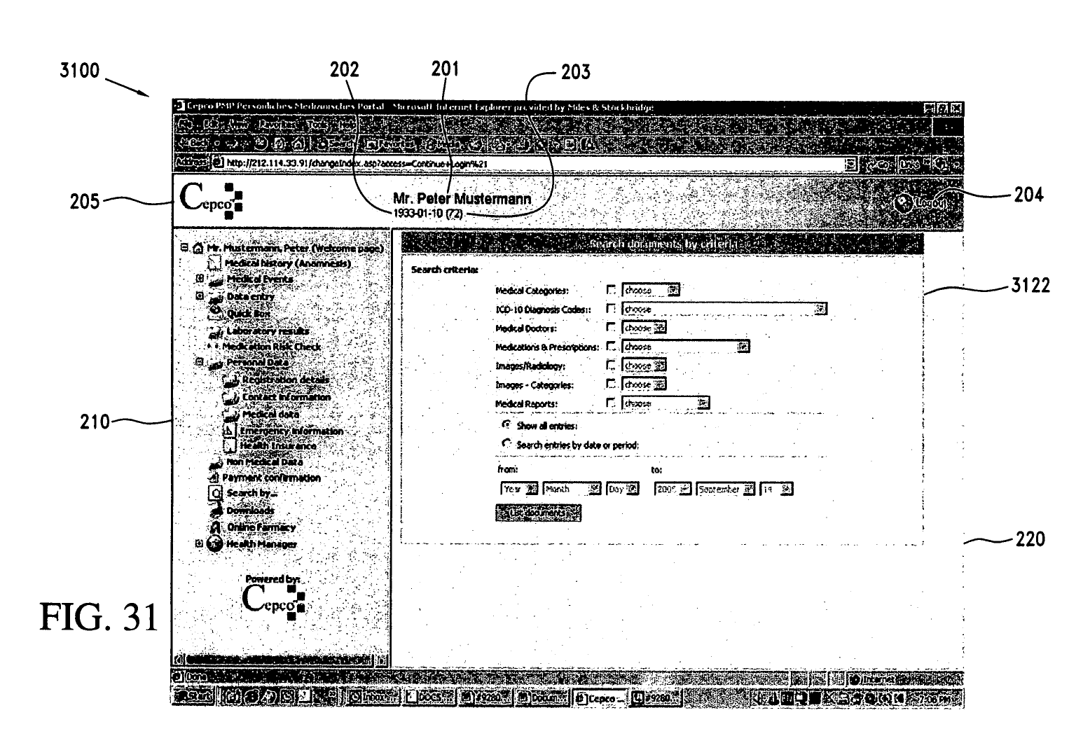

FIG. 31 is a screen shot of a search documents page 3100 of the web-based implementation of the PMP, in accordance with one or more embodiments of the present invention. In FIG. 31, lower right section 220 may include a search documents by criteria box 3122 with multiple criteria from which to select to perform the search. For example, these search criteria may include, but are not limited to, medical categories, ICD-10 categories, medical doctors, medications and prescriptions, images/radiology, images- categories, and medical reports and may be optionally limited to specific time periods.

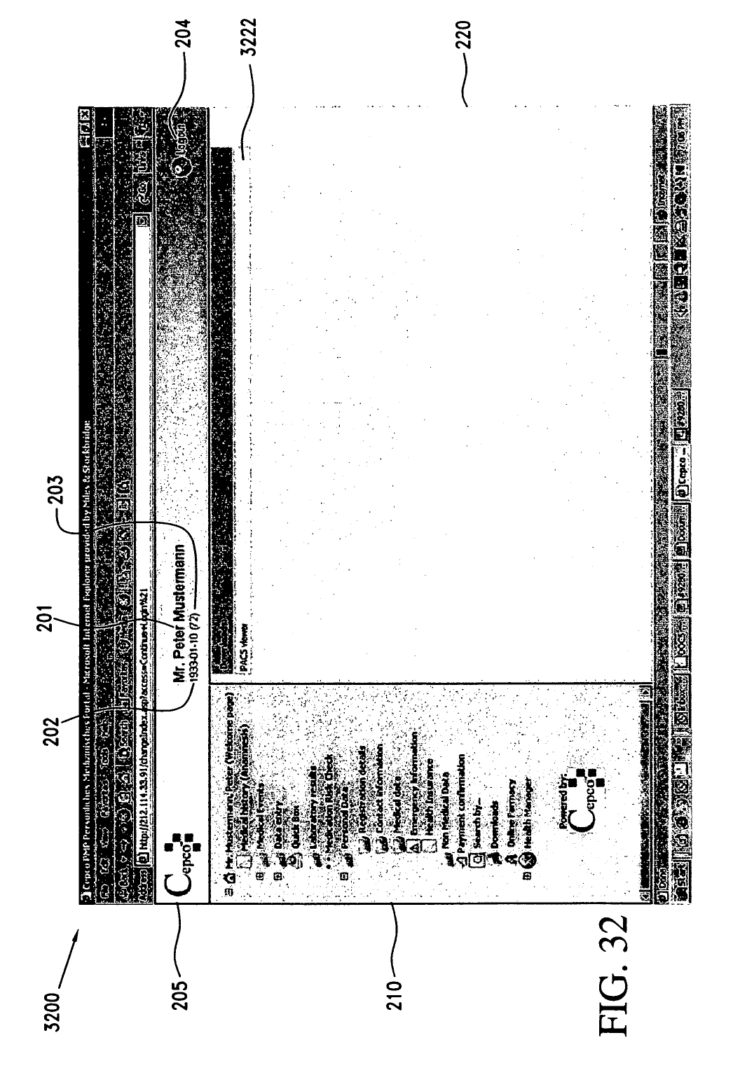

FIG. 32 is a screen shot of a download page 3200 of the web-based implementation of the PMP, in accordance with one or more embodiments of the present invention. In FIG. 32, lower right section 220 may include a download box 3222 with a list of free programs, plug-ins, etc from which to select to download for use to by the patient and/or his doctors to view documents, for example, the IPACS radiology viewer is available and permits users to view radiology images.

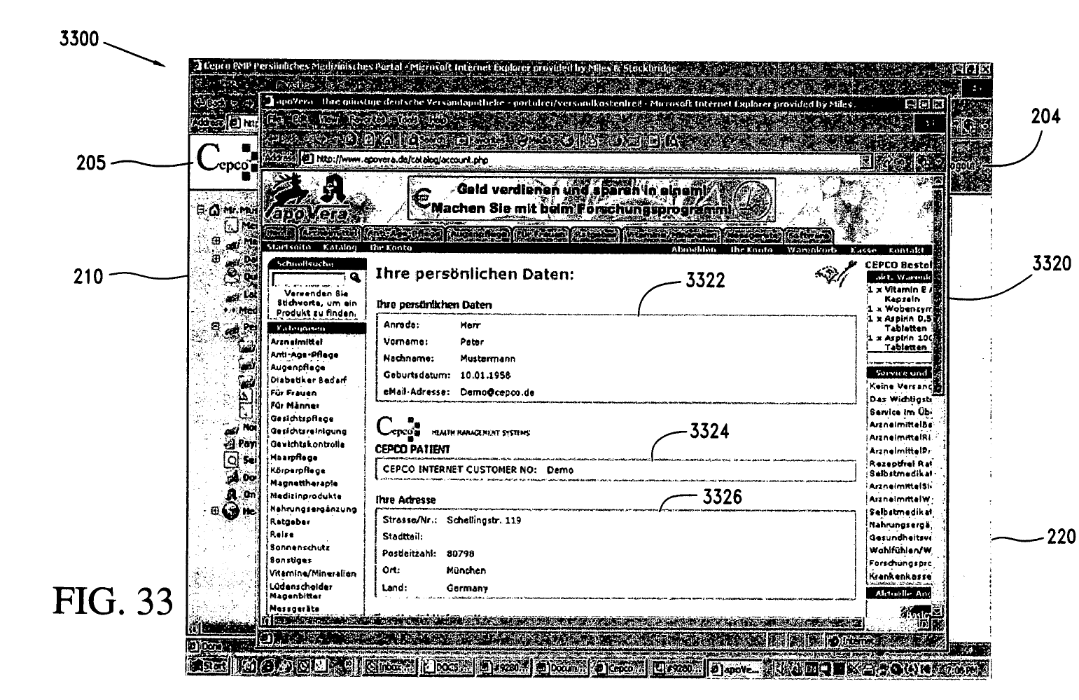

FIG. 33 is a screen shot of an online pharmacy page 3300 of the web-based implementation of the PMP, in accordance with one or more embodiments of the present invention. In FIG. 33, an online pharmacy window 3320 may be overlaid over online pharmacy page 3300 and may include personal data about the user. For example, a user information box 3322 with the patient's name, date of birth and email address; an internet customer number box 3324 with the patient's unique customer number; an address box 3326 with the user's mailing address, a telephone number box (not shown) with the user's telephone and facsimile numbers, and an options box (also not shown) with a list of optional informational mailings/e-mailings.

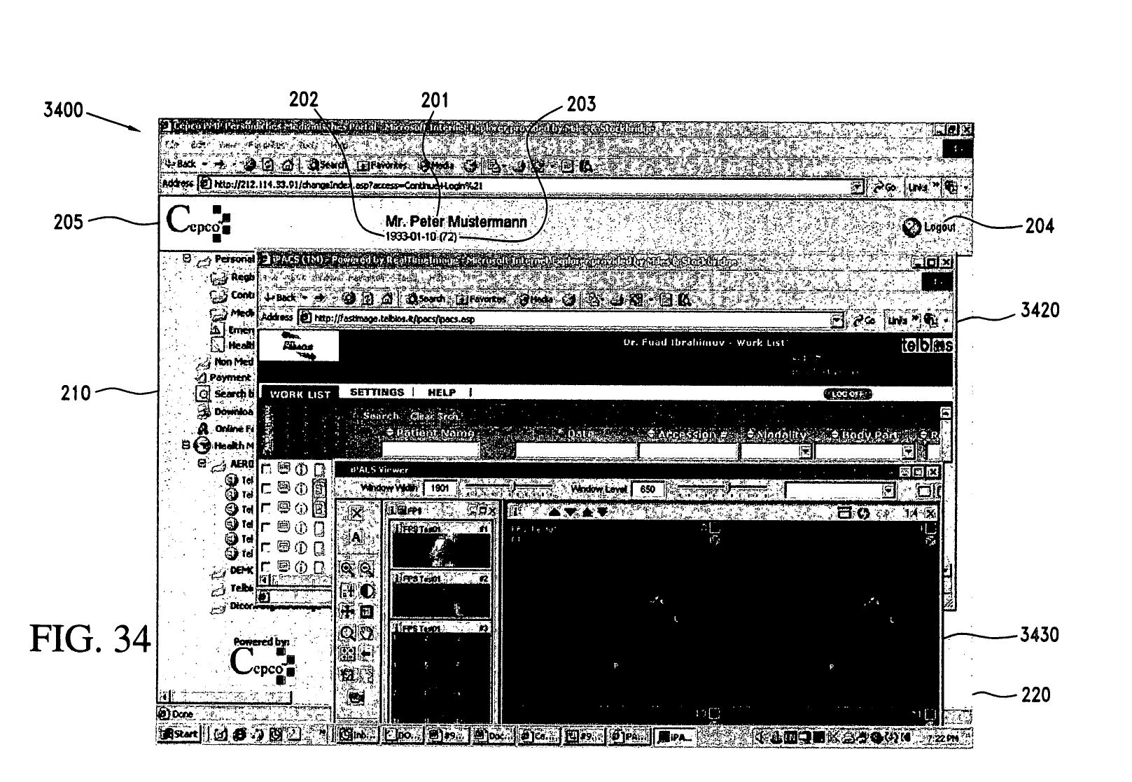

FIG. 34 is a screen shot of a health manager page 3400 of the web-based implementation of the PMP, in accordance with one or more embodiments of the present invention. In FIG. 34, a health manager window 3320 that may be overlaid over health manager page 3400 and may include a listing of radiology images and reports on the user, and an IPACS viewer window that may be overlaid over health manager window 3320 and health manager page 3400 and may display a selected user radiology image from health manager window 3320.

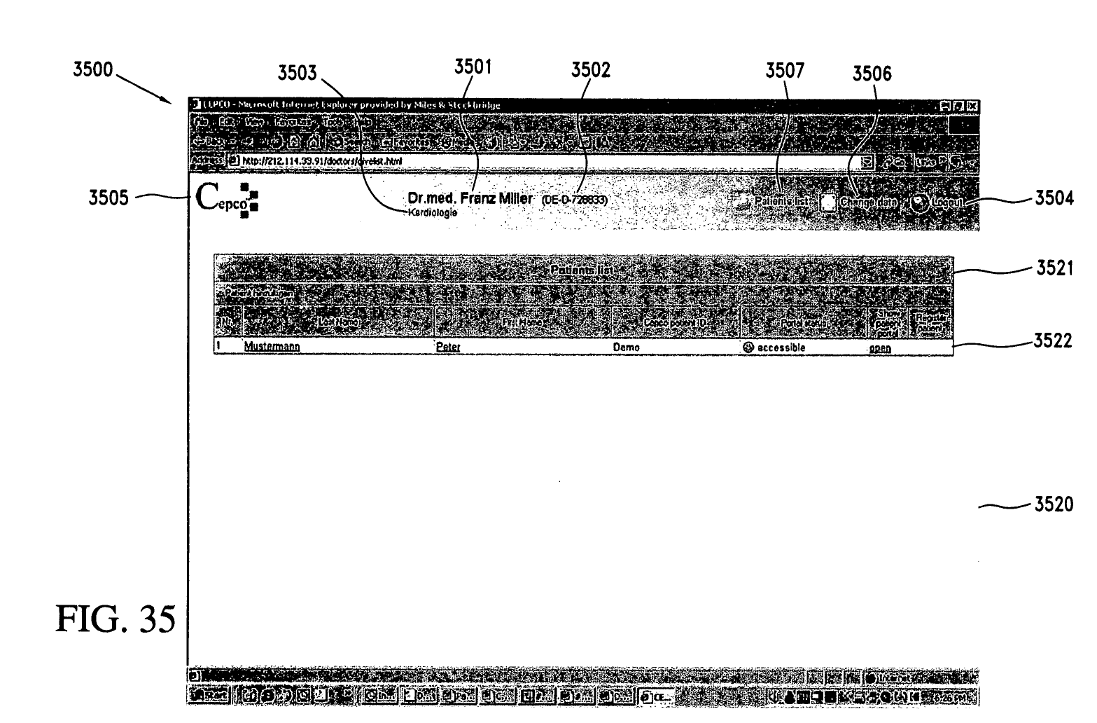

In accordance with one or more embodiments of the present invention, in general, doctors and MSP (Medical Professional Services) will have unrestricted access to the personal medical information that they entered into a patient's PMP, as long as such doctor or MSP has been registered with the service (MDP—Medical Doctor Portal, see FIGS. 35-37, below). This seemingly contradictory position, vis-á-vis the patients exclusive authority over his/her personal medical data, results from the requirement that a doctor or MSP (Medical Service Provider) must maintain their own patient data/records between 7 to 30 years, depending on the character of the data and on varying national laws. In addition, the MD and/or MSP, if registered with the system, will always have the right to unrestricted access of the Ananmesis-Sheet in the PMP, which is where all medication, vaccinations, allergies and diseases are recorded in coded form. While the doctor or MSP will not be able to see the full details of Medical Reports, Diagnosis or Therapy Instructions of other doctors or MSP, their access to the coded information (Diagnosis in ICD-10, Medication taken from national pharmacological databases, Lab-Tests taken coded from laboratories) is crucial for the use of the PMP and the welfare and benefit of the patient. Only when all of this coded information is available to the doctor and/or MSP can they make a proper, complete and responsible Diagnosis and Therapy Recommendation. In general, in order for a doctor or MSP to be able to access patient data the patient has to approve each individual doctor and/or MSP through his AAT as one of his authorized medical service. Without the patient's authorization, no doctor and/or MSP can access the patient's PMP.

FIG. 35 is a screen shot of a welcome page 3500 of a web-based implementation of the MDP that may be displayed after successfully logging on to the MDP, in accordance with one or more embodiments of the present invention. Prior to being able to logon to this page, Dr. Franz Miller, whose specialty is Cardiology and is Mr. Mustermann's doctor, registered with the MDP system as a doctor. In FIG. 35, a welcome page 3500 may include specific data including a doctor name 3501, a doctor identification/license number 3502 and a specialty 3503, as well as a logout button/icon 3504 in a top section 3505 of welcome page 2500 to log out of the MDP. Welcome page 3500 may also include a lower section 3520 in which a patient list banner 3521, and a patient listing box 3522 with of all of the patients that have authorized the doctor to access the personal medical information stored in the patients' individual Pumps. In addition, top section 3505 has a patients list button 3507 that may be used to open and close the patients listing 3522 and a change data button 3506 that may be used to open one or more patient listings to change and/or add to the patient's personal medical information in their PMP.

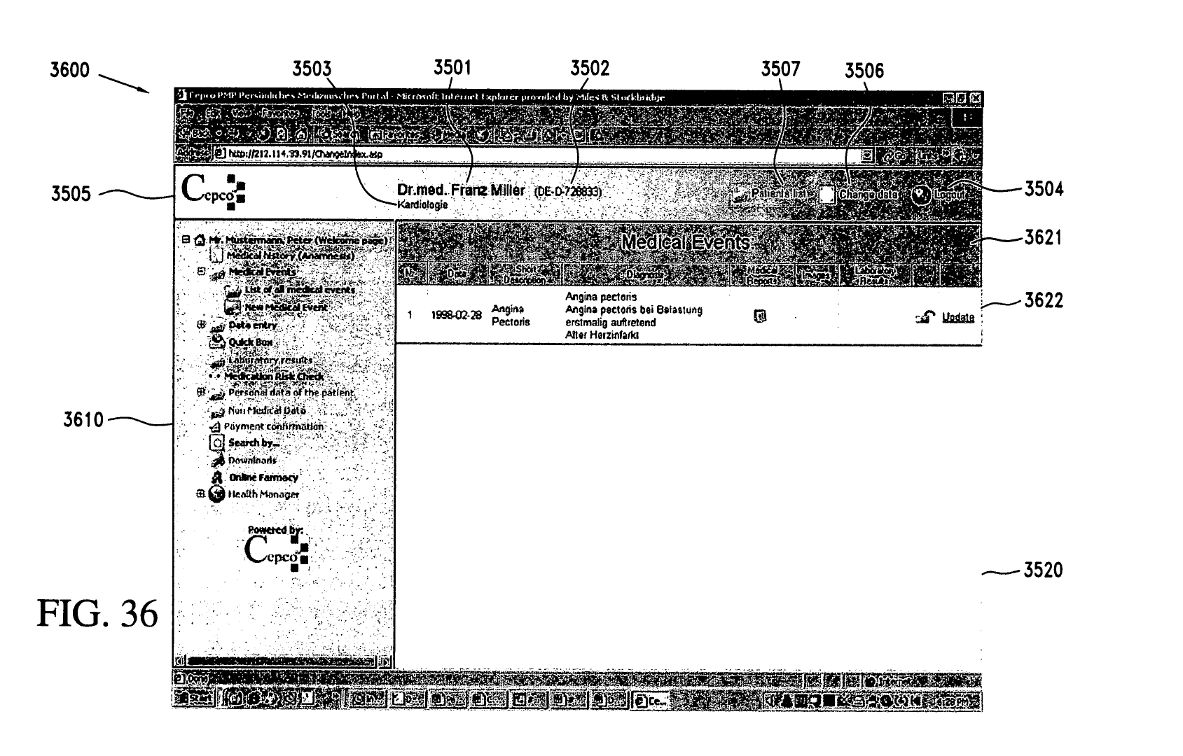

FIG. 36 is a screen shot of a summary medical events page 3600 of the web-based implementation of the MDP, in accordance with one or more embodiments of the present invention. In FIG. 36, lower right section 3520 may include a medical events header 3621 to identify the subsequent information as medical event 1, which are identified by 422, 423, 424, respectively, that the patient has had. Associated with each medical event is a number, a date of the event, a short description of the event, a diagnosis, any associated medical reports, any associated images, any associated laboratory results, a lock/unlock button that allows the patient to close a medical event for viewing while it does not affect the viewing-options at any other medical event (the tool enables the patient to hide or block information from third parties while keeping other information open to review); and an update column with a link to the data associated with that event that may be selected to edit the information associated with the event.

In FIG. 35, Dr. Miller finds in his list of patients Mr. Mustermann's name and opens Mr. Mustermann's PMP as seen in FIG. 36. Although the Mr. Mustermann's PMP appears identical to the one Mr. Mustermann accessed in FIG. 4, they are not the same. Unlike in FIG. 4, Dr. Miller finds only one of Mr. Mustermann's medical cases accessible to him, namely his own medical case concerning the angina pectoris. Dr. Miller cannot see any other medical case from any other MD who treats Mr. Mustermann (=the patient) and he also has no access to the personal-data-area of the patient (as shown by those areas being deactivated and shown in grey-scale). However, Dr. Miller may still have full access to the coded Anamnesis-sheet (identical to what the patient saw in FIG. 3).

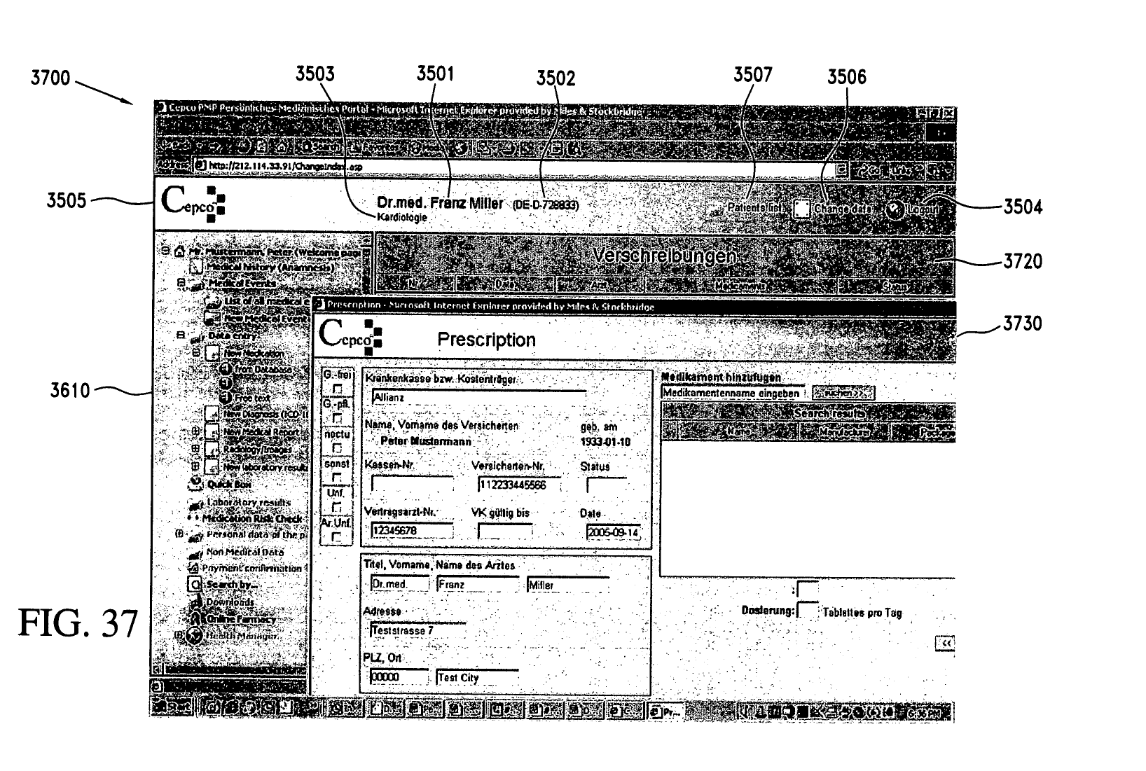

Through his MDP, Dr. Miller may have an integrated E-Prescription Formulary to automatically connect to pharmacological databases and to the Internet-Pharmacy (although the present examples are in German, they correspond with the US forms accordingly) as seen in FIG. 37. Dr. Miller obtains, while prescribing the new medication, an automatic medication-incompatibility test result, taken from the database of the patient whilst prescribing the medication; alternatively, Dr. Miller can click at any given time on the Medication-Incompatibility-Risk-Check-Button and view all the patients present and past medication and their possible interaction with each other of with lab-results or ICD-10 diagnostic codes.

FIG. 37 is a screen shot of a new medicine page 3700 of the web-based implementation of the PMP of FIGS. 11 and 12 and the MDP of FIG. 35, in accordance with one or more embodiments of the present invention. In FIG. 37, a new medication box 3720 (Vershreibungen) may include an add prescription button that upon being selected causes prescription window 3730 to be overlaid on new medicine page 3700 and over the add prescription button. Dr. Miller may use prescription window 3730 to enter a prescription order for Mr. Mustermann in the Internet Pharmacy, a prescription that Mr. Mustermann may subsequently order from the Internet Pharmacy for delivery.

In accordance with one or more embodiments of the present invention, the system may function to allow the individual patient to use his/her stored personal medical data and to connect the data to proprietary data profiling tools or to third-party data profiling tools. By doing that, a patient who enters and takes care of all or most of his/her personal medical data and details, may achieve a much higher level of basic medical data analysis than any hospital or doctor may be able to do, because as they base their data evaluation only on the data available at that specific doctor or institute. As a result, a patient will be able to manage his/her health in a very efficient way without the need for daily contact with his/her physician(s). By using embodiments of the system, the patient may be able to execute his/her constitutional right on self-determination, a request that is set by the US Patients Rights Act, by the Health Secretary, and by the President of the US.

Also, in accordance with one or more embodiments of the present invention, as part of the patients constitutional right to decide what shall happen with his personal medical data, and to whom he/she might grant the right to use such data (in anonymous format) for R&D (research & development) or data harvesting, the system's built-in technologies enable the patient to simply mark the chosen data-segments in his/her PMP, and release this marked data to the selected recipient. Such selective data analysis may be made available overnight and will grant, for example, a patient newly diagnosed with a dangerous or deadly disease or accident (cancer, virus, broken body parts, head-traumas, etc.) to search the system database for similar cases or events and/or to call up various therapeutic or surgical options overnight.

In accordance with one or more embodiments of the present invention, future or present modern medical technologies may be WEB-based and may be downloaded to and installed on each patient's computer, allowing every holder of a PMP to connect to valuable data analysis tools, thus avoiding that such technologies will be locked-away in professional institutions for private use only, and not available to the patient. As an example, in one or more embodiments, a patient's Radiology Study (X-Ray, CT, MR, US, etc.) may be made available to the patient via the WEB to be viewed by the patient and/or his doctors by simply downloading a radiology viewer to the patient's and/or each doctor's PC. Presently, such technologies are only available to doctors and Hospitals.

In addition, in accordance with one or more embodiments of the present invention, the system may enable the patient to enter his/her own medications, laboratory results and nationally or internationally (WHO) coded Diagnosis (ICD-9, 10) from publicly accessible professional databases and interface them in his/her own PMP with data analysis and risk analysis programs. Such programs may likely show to the patient contradictory/dangerous treatment regimens and/or disease trends long before his/her doctor may recognize them. For example, the programs may show that a currently prescribed medication cannot or should not be taken by the patient, because it interferes with the patient's medical profile (i.e., allergies, other medications, or diseases registered in coded form). The creation and installation of such MDPs have been demanded by the Health Secretary with the request to make them available to the patient and his doctors.

Another benefit of embodiments of the present invention is that the patient may now freely access his/her data at any time and make it available to other medical professionals for second opinion or for practical cross analysis. This will help to reduce malpractice and false medical reports while enabling the patient to crosscheck his/her reports and help, alone or in consultation with, his MD. The patient may now also participate in selecting proper therapies and/or prevention programs.

As a result, in accordance with one or more embodiments of the present invention, the individual patient will, in general, become the central data holder for his/her medical information to whom doctors and other healthcare providers may connect when a patient is in treatment and/or the doctor, etc. needs historic data, regardless of whether written material (reports), Images or Lab test results. This central position of the patient, holding and administering his/her own (medical) data would constitute the first step towards fulfilling the law, enabling the patient to do technically what the law has dictated already years before.

The portal may therefore be considered a consumer tool that allows the individual patient to store, manage and analyze all his/her personal and family health matters. The data remains under the control of the patient who can make the data available to a doctor, an insurance provider, etc., in full or partially. No MSP has any right to view, add or delete any data unless the patient grants his/her consent. This right is constitutionally guaranteed and can be restricted only in rare cases, such as, an epidemic outbreak of diseases, in the event of incapacitation or by age, for example, parents may have to run the PMP for their children until the children reach the age of majority, which may be 18 or 21 years of age.

In accordance with embodiments of the present invention, the integrated data repository described above may be used to interact with a patient's portal data. As a result, every purchase of medication may be recorded in the patient's portal and automatically cross-evaluated against the patient's former laboratory results, ICD-10 Diagnostic Codes, medications, medical reports, etc. to determine if any contraindications may be indicated.

In accordance with one or more embodiments of the present invention, the system may include an internet pharmacy with the following basic functions: the PMP may link all medications directly to the Internet pharmacy; a desired medication may be bought by selecting the medication, for example, by moving the cursor over and clicking on an icon representing the medication; and each patient may have his/her own personal shopping account at the Internet pharmacy. The requested medication is already marked and listed. There are a number of features on that page:

On the right function bar, on top, the red marker can be found:

i) what to order; and below;
ii) present actual basket of ordered merchandise. It is to be clicked on that and all presently ordered products, not only. medication, can be found; and
iii) further and below another header is found called previous orders (that means: all orders made already at an. earlier stage).

In accordance with one or more embodiments of the present invention, the Internet pharmacy may operate on a triple-bonus-system, which may provide a direct price advantage (lower price) for members; an additional bonus system to earn mileage, money, and/or similar rewards for the patient. These bonus' may be used by the patient to pay his/her annual PMP cost from the bonus system and/or to purchase products and services, including DMPs at reduced costs and/or for no cost. Similarly, each doctor may also build a bonus account that may mean account for several thousands of extra income during each quarter of a year, depending, of course, on the number of patients the doctor has in the system.

In accordance with one or more embodiments of the present invention, the Internet pharmacy system may work solely on structured data that is taken from databases including, for example, medication details like ingredients, incompatibilities and prices. The system may guide the patient through DMPs that combine selected parameters (e.g., Weight. BP, and BEG) together with Lab-Results (e.g., Cholesterol, HOL, LDL, Triglyceride, Glucose, and/or any other MD-marked Lab-Result) and/or any other data source chosen by the patient or his doctors. In addition, the system may be linked simultaneously to multiple national and/or international pharmaceutical databases, for example, the German and US SCHOLZ Pharmaceutical Databases. This allows patients from the US and from the EU, and all traveling patients, to access information on their medication regardless of its geographical origin. By linking up with national and/or international pharmacological databases, the system may make sure, that all manufacturer-defined medication is reached directly and/or together with governmental and/or regional defined medication parameters.

In accordance with an embodiment of the present invention, a system may include an e-prescription component that may provide an electronic connection to prescribed medication. This component may electronically and securely connect a prescribing doctor/physician with a pharmacy, either an e-pharmacy and/or a regular “brick and mortar” pharmacy selected by a patient, so that the doctor/physician may electronically send a prescription for the patient directly to that pharmacy. This may significantly reduce the time between when a patient receives a prescription and when it gets filled. For example, if the doctor sends the prescription to the brick and mortar pharmacy, the pharmacy can be filling the prescription while the patient is in route, instead of the current procedure of the patient bringing the paper prescription to the pharmacy and then having to wait while it is filled. An added benefit of such a system is the potential for the reduction of errors in filling each prescription caused by the pharmacist not being able to read the doctor's handwriting. Unfortunately, there are presently neither national (i.e., Germany, Sweden, UK, etc.) nor international (i.e., EU-wide US-wide or WHO) defined and accepted E-prescription-systems adopted. Although some HMOs use E-Prescription, most MDs (??) do neither, because they do not have the PCs or the needed networking connectivity to comply.

In accordance with embodiments of the present invention, the system may provide doctors with full data availability while allowing them to access automatic and/or customized analytical assistance. For example, the automatic and/or customized analytical assistance may include: an automatic medication incompatibility check; an automatic patient profiling by cross-evaluating ICD-10 diagnostic codes, medications and lab-results; an ability to create a data-interface and data-connectivity with a patient's static data (e.g., age, sex, etc.) and dynamic data (weight, former diseases by ICD-10, Allergies, Vaccinations, etc.); doctor designed queries that allow doctors to access related data (e.g., cardiology, orthopedic, oncology, etc.); and/or connect some or all of the above with modern, professionally designed DMPs whose basic data repository comes from the patient while additional data may originate from either doctors (e.g., cardiologists, radiologists, oncologists, diabetics, clinical studies, etc.), or from pharmaceutical sources (e.g., drug manufacturers), or from both. This decentralized data acquisition allows the system to work with any medical source and/or study without compromising the study's master data integrity. Similarly, the patient's data integrity and his/her right to unhindered access to all of his/her data are fully secured.

In accordance with one or more embodiments of the present invention, the system may include a state-of-the-art radiology viewing system (so called ‘streaming’) that may operate on original, non-compressed data and that may be used with the latest state-of-the art tele-radiology standard, e.g., in full DICOM-3 standard. Of course, all of the radiology data may be available to patients and their doctors, if authorized by the patient. The system may maintain an historical repository of all imaging data so that it may be used for any type of future data analysis. For example, this may provide a valuable resource for use in the area of breast cancer screening (mammography), as well as in any other medical fields.

Internet Providers (AOL, T-Online, Yahoo, Focus-online others) and Wireless Phone Companies (e.g., Orange; Vodafone; etc.) who now offer broadband UMTS services searching for new content on their services and plan to promote such services to their clients. As a result, Medical Supervision and Medical Prevention are taken out from the restricted capacities and capabilities of private and public Health Services and handed back into the hands of the consumers.

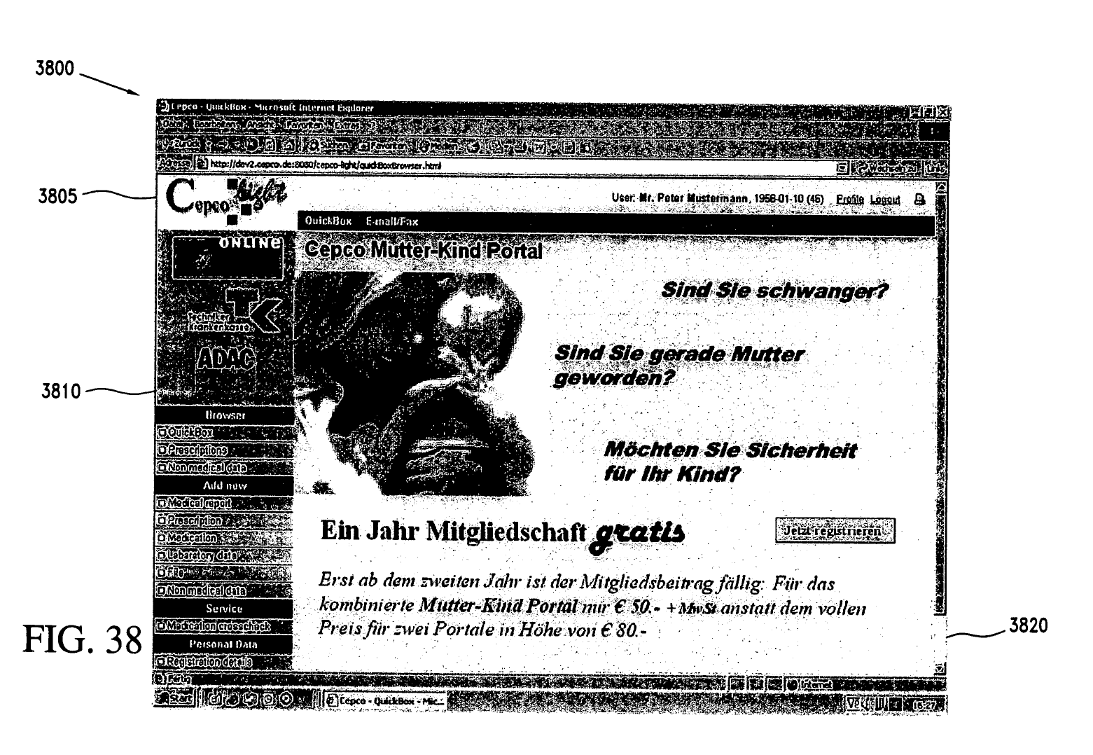

In order to help Internet-Services to promote such complex services to their clients, a simpler version called Light, as seen in FIG. 38 represents a low-cost first step towards full medical data integrity. FIG. 38 is a screen shot of a welcome page 3800 of the Light version of the PMP system previously described, in accordance with one or more embodiments of the present invention. In FIG. 38, welcome page 3800 may include a top section 3805, a lower left section 3810 in which the options to control and/or access the data in the Light version are located, and a lower right section 3820 in which information about the service may be provided.

The Light version is a new, slim design developed for market access by mass-media and mass internet-marketing organizations and allows patients and their doctors to enter medical data in a simple and efficient way, namely by E-Mail and FAX while keeping open the option for proper online-data transfer through an SSL protected PMP—Personal Medical Portal. On push-button, or by booking advanced PMPs, every patient can upgrade his Light version to the regular, full-fledged PMP program.

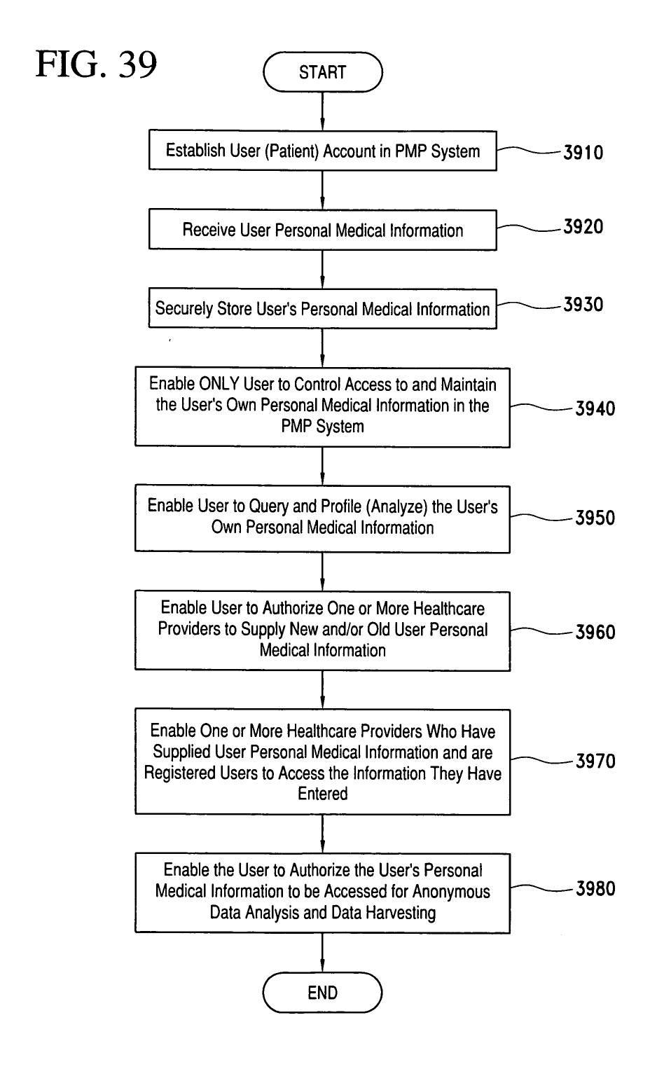

FIG. 39 is a flow diagram of a method of implementing a patient personal medical portal to be controlled and accessed by the patient, in accordance with one or more embodiments of the present invention. In the method in FIG. 39, a user account may be established (3910) in a personal medical portal (PMP) database for a user (i.e., a patient who has registered for the PMP service) and the user's personal medical information may be received (3920) and securely stored (3930) in the PMP database and enabled (3940) such that the user to whom the user personal medical information pertains has sole control of who can access and maintain the user's personal medical information. In the method the user may further be enabled (3950) to query and profile (i.e., analyze) the user's own personal medical information, and to be enabled (3960) to authorize one or more healthcare providers to supply new and/or old user personal medical information. For example, the query and profile capabilities of the system for each patient may include, but are not limited to, being able to query by medication taken; medication incompatibility tests; disease by group (e.g., cardiology, orthopedic, etc.); individual disease (e.g., angina pectoris); ICD-10 code; radiology type (e.g., X-ray, MR, MRI, CT, etc.); specific laboratory result (e.g., triglyceride, cholesterol, etc.); laboratory results comparison; cross-evaluation of laboratory results with weight; and custom tailored queries relating to any database items to any other database items. Similarly, the query and profile capabilities of the system for all patients in the database may include, but are not limited to, being able to query by the frequencies certain medication is taken; frequency of medication incompatibilities; frequencies of certain diseases by group (e.g., cardiology, orthopedic, etc.); frequencies of individual disease (e.g., angina pectoris); frequencies of ICD-10 codes; frequency of radiology type (e.g., X-ray, MR, MRI, CT, etc.); frequency of interrelations of certain laboratory results with, for example, weight and/or high blood pressure; and custom tailored queries relating to any database items to any other database items. In the method the one or more healthcare providers who supply new and/or old user personal medical information may be enabled (3970) to access the new and/or old user personal medical information that they individually supplied without further authorization from the user. In the method the user may still further be enabled (3980) to authorize the user's personal medical information to be accessed for anonymous data analysis and data harvesting by research organizations and universities.

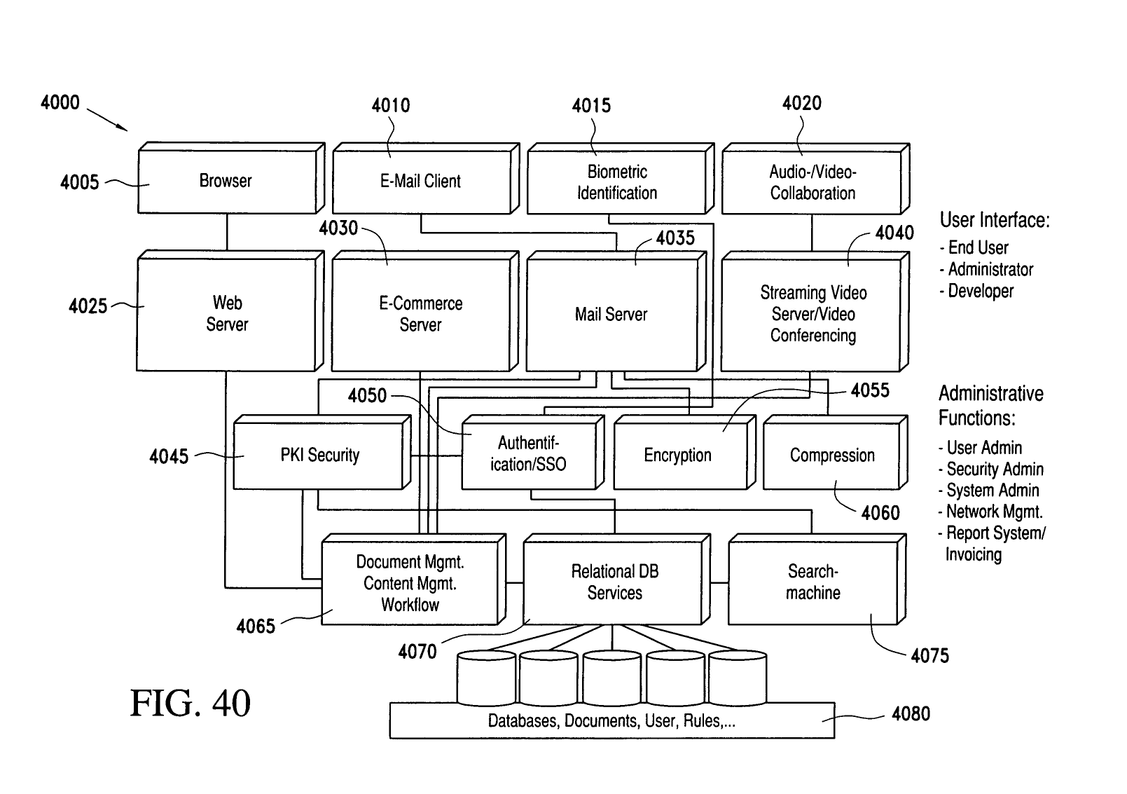

FIG. 40 is a block diagram of a system infrastructure 4000 for a PMP that may be implemented to enable direct patient access and control over the patient's personal medical data and information, in accordance with one or more embodiments of the present invention. In FIG. 40, system infrastructure 4000 may include user-specific user interfaces for end users, system administrators, and developers; and may perform administrative functions including user administration, security administration, system administration, network management, and report system/invoicing. System infrastructure 4000 may provide through the user interface a browser 4005; an e-mail client 4010; a biometric identification module 4015, including for example fingerprint-identification and/or eyeball-identification and any other present or future biometric technique that will enhance security and protect the patient's privacy on the Internet; an audio/video collaboration module 4020; a web server 4025, an E-commerce server 4030; a mail server 4035; a streaming video server/ video conferencing module 4040; a PKI component 4045; an authentication /Single Sign-on (SSO) component 4050; an encryption component 4055; a data compression component 4060; a document management and content management workflow component 4065; a relational database services component 4070; a search engine component 4075; and databases, documents, user(s), objects, rules (e.g., business, etc.), etc. 4080. In addition, one or more user interfaces may be provided, including but not limited to, end user, developer, and administrator interfaces. It is hereby noted that embodiments of the system follow the recommendations of the US-Medical Record Institute to design the base for future Electronic Health Records (EHS) on the XML data system rather than on SQL. While most hospitals and practice software are based on DOS or on SQL (neither allow instant data-communication on the Internet), embodiments of the system may be programmed using a XML Database, for example, a database created using Tamino XML Server from Software AG, Germany). Hospitals presently install add-on features that allow them to change their SQL data into useable XML. Still, at the end of the transaction such XML-data may not stored, but instead destroyed. Embodiments of the present system may store all data in XML, allowing instant use not only on the WEB but also by wireless communication systems and tools. In order to provide the maximum security that modem WEB-technology can provide, individual functions of the system such as Registration Details, Medical Data and Reports or Messages (E-Mail, Fax) operate on separate servers. In the event of an unlikely hostile break-in into the system, the attacker (hacker) could not identify a document with the name of a patient, or an E-Mail belonging to a specific patient portal. Moreover, encryption, digital signatures and other data-protection-mechanisms may also run on independent servers. There is a contradiction in medical professional circles in that, on the one side they need and demand epidemiology data, but on the other side they demand that doctors and Hospitals encrypt that data. The system uses encryption technologies to allow instant decryption once the patient calls his portal, and provides both: Data Security towards third parties and Data Accessibility and Usability once needed by the patient.

An advantage of the new and inventive system is the that patients may be supplied with laboratory data, medication data including substances, ICD-10 Diagnostic Codes, medical reports, and/or radiology images including radiology medical reports to form a medical profile of the patient. Any amendment realized by newly input data may be immediately interconnected to all parameters stored for the particular patient data. As a result, if for example a patient is supplied with new laboratory test result data indicating that the patent possibly suffers from angina pectoris, the system may immediately issue a warning if a medicine that the patient is currently taking should no longer be taken, because this particular medicine could possibly increase the disease angina pectoris. Such capability may be implemented in one or more DMPs. Such DMPs have never been used by patients over the WEB, but instead only by doctors as a so-called “insular solution.” As a result of the general concept of the inventive system the information gap on the patient's side is closed so that he/she has got more information and each new MD retrieves his/her information for diagnosis from this patient-bound information pool.

The above description is considered to illustrate the general principles of the invention and is in no way to be construed so as to limit the invention as expressed in the appending claims to the exact construction, implementations and versions shown and described.

What is claimed is:

1. A personal medical information storage and analysis system comprising:
a personal medical portal component in communication with at least one secure patient database and in communication with a patient with secure personal medical information stored in said at least one secure patient database;
said at least one secure patient database being a personal medical portal component in communication with at least one secure patient database within which personal medical information on a patient is to be stored;
an access control component in communication with said at least one secure patient database for the patient to enable optional, patient authorized access to said personal medical information by at least one healthcare provider;
a data profiling component in communication with said at least one secure patient database and said data profiling component to be used by the patient to prepare a self-profile from the patient's secure personal medical information; and
said at least one secure patient database being accessible by the at least one healthcare provider only for the personal medical information that each individually provided to the at least one secure patient database without further authorization from the patient.

2. The personal medical information storage and analysis system of claim 1 wherein the access is enabled by said patient by authorizing each of the at least one healthcare provider to access said personal medical portal through a medical doctor portal.

3. The personal medical information storage and analysis system of claim 2 wherein said medical doctor portal has less functionality and information control capabilities than said personal medical portal.

4. The personal medical information storage and analysis system of claim 1 wherein said personal medical portal for said patient has complete control over all of said patient's personal medical information.

5. The personal medical information storage and analysis system of claim 1 further comprising:
an Internet pharmacy to receive an electronic prescription from a doctor through a medical doctor portal connected to the patient's personal medical portal and to dispense medicine in accordance with the electronic prescription to said patient.

6. The personal medical information storage and analysis system of claim 1 wherein said system is written in XML.

7. The personal medical information storage and analysis system of claim 1 wherein the system is web-based.

8. The personal medical information storage and analysis system of claim 1 wherein said patient accesses said system over a network.

9. The personal medical information storage and analysis system of claim 8 wherein said network is the Internet.

10. A method for providing patient controlled personal medical information storage and analysis, the method comprising:
establishing an account in a personal medical portal for a user;
receiving personal medical information about the user;
securely storing the personal medical information about the user in a database associated with the personal medical portal;
enabling only the user to control access and maintain the personal medical information about the user;
enabling the user to query and profile the personal medical information about the user;
enabling the user to be able to authorize one or more healthcare providers to supply new and/or old user personal medical information;
enabling the one or more healthcare providers who have supplied personal medical information about the user and are also registered users to automatically have access to all the personal medical information about the user that they supplied; and
enabling the user to authorize the personal medical information about the user to be accessed for anonymous data analysis and data harvesting.

11. The method for providing patient controlled personal medical information storage and analysis of claim 10, the method further comprising:
receiving the personal medical information about the user from the user.

12. The method of claim 10, wherein the establishing the user account in the PMP comprises:
instantiating a personal medical portal object for the user;
associating the user with the personal medical portal;
associating a plurality of rules with the personal medical portal; and
associating a security level with the personal medical portal that only permits the user to control access to the personal medical portal.

13. The method of claim 10, wherein the receiving personal medical information about the user comprises receiving at least one of:
an image;
a laboratory result;
a medical report;
a medical event; and
a diagnosis.

14. The method of claim 10, wherein the enabling the user to query and profile the user's own medical information comprises:
enabling the user to create the profile using at least one third party data analysis tool.

15. A machine-readable medium having stored thereon a plurality of executable instructions to perform a method comprising:
establishing an account in a personal medical portal for a user;
receiving personal medical information about the user;
securely storing the personal medical information about the user in a database associated with the personal medical portal;
enabling only the user to control access and maintain the personal medical information about the user;
enabling the user to query and profile the personal medical information about the user;
enabling the user to authorize one or more healthcare providers to supply new and/or old personal medical information about the user;
enabling the one or more healthcare providers who have supplied personal medical information about the user and are also registered users to automatically have access to all the personal medical information about the user that they supplied; and
enabling the user to authorize the personal medical information about the user to be accessed for anonymous data analysis and data harvesting.

16. The machine-readable medium of claim 15, wherein the method further comprises:
receiving the personal medical information about the user from the user.

17. The machine-readable medium of claim 15, wherein the establishing the user account in the PMP comprises:
instantiating a personal medical portal object for the user;
associating the user with the personal medical portal;
associating a plurality of rules with the personal medical portal; and
associating a security level with the personal medical portal that only permits the user to control access to the personal medical portal.

18. The machine-readable medium of claim 15, wherein the receiving personal medical information about the user comprises receiving at least one of:
an image;
a laboratory result;
a medical report;
a medical event; and
a diagnosis.

19. The machine-readable medium of claim 15, wherein the receiving personal medical information about the user comprises:
receiving structured data.

20. The machine-readable medium of claim 15, wherein the enabling the user to query and profile the user's own personal medical information comprises:
enabling the user to create the profile using at least one third party data analysis tool.
